(19) United States
(12) Patent Application Publication
(10) Pub. No.: US 2023/0095922 A1
(43) Pub. Date: Mar. 30, 2023

(54) POLARIZING PLATE AND DISPLAY DEVICE

(71) Applicant: Sharp Display Technology Corporation, Kameyama City (JP)

(72) Inventors: Miho YAMADA, Kameyama City (JP); Akira SAKAI, Kameyama City (JP); Masahiro HASEGAWA, Kameyama City (JP); Yuichi KAWAHIRA, Kameyama City (JP); Hiroaki ASAGI, Kameyama City (JP)

(21) Appl. No.: 17/940,103

(22) Filed: Sep. 8, 2022

(30) Foreign Application Priority Data
Sep. 15, 2021 (JP) 2021-150507

(51) Int. Cl. G02B 5/30; C09K 19/56

(52) U.S. Cl. CPC G02B 5/3016; C09K 19/56; G02F 1/133531

(57) ABSTRACT

Provided are a polarizing plate including a polarizing layer containing a lyotropic liquid crystal compound and capable of achieving uniform polarization properties over a large area, and a display device equipped with the polarizing plate. The polarizing plate includes: an alignment film; and a polarizing layer on the alignment film. The alignment film contains an alignment film polymer, has a static contact angle with water of 60° or smaller, and has a slow axis. The polarizing layer contains a lyotropic liquid crystal compound and has an absorption axis parallel to the above slow axis. The lyotropic liquid crystal compound is preferably dichroic.

### CROSS-REFERENCE TO RELATED APPLICATIONS

The present application claims priority under 35 U.S.C. § 119 to Japanese Patent Application No. 2021-150507 filed on Sep. 15, 2021, the contents of which are incorporated herein by reference in their entirety.

### BACKGROUND OF THE INVENTION

### Field of the Invention

The following disclosure relates to polarizing plates and display devices.

### Description of Related Art

There is an increasing demand for flexibilization of display devices as typified by organic electroluminescent display devices (Organic Light Emitting Diodes: OLEDs) and liquid crystal display devices (LCDs), with the aim of achieving curved displays whose display surface is curved, foldable displays, or rollable displays. In particular, expectations are high for flexibilization of OLEDs, which require no members such as a backlight and are thus structurally advantageous in terms of thickness reduction.

Some display devices include a circularly polarizing plate attached to the outside of the display panel to achieve favorable display quality and designability. For example, OLEDs, which include a cathode made of a metal, cause a significant internal reflection in the display panel. To deal with this phenomenon, OLEDs include a circularly polarizing plate having an anti-reflection effect. The circular polarizing plate has therefore been demanded to have higher bendability for flexibilization.

Conventionally, PVA iodine polarizing plates including a polyvinyl alcohol film (PVA film) to which an iodine complex is adsorbed have been mainly used as polarizing plates. However, PVA iodine polarizing plates disadvantageously lack heat resistance and are thick to have poor bendability. These disadvantages have been often issues to be solved in the field of foldable OLEDs, where development has been accelerated in recent years.

To solve these issues, a method for producing anisotropic dye films (polarizing plates) is now considered as an alternative technique to PVA-iodine polarizing plates. Specifically, the production method includes forming a film containing dichroic dye molecules by a wet deposition method including application of a solution containing dichroic dye molecules, and aligning the dichroic dye molecules, thereby producing an anisotropic dye film (polarizing plate). Expectations are placed on this technique because the anisotropic dye films thus produced have better heat resistance and are thinner than PVA iodine polarizing plates and therefore are likely to have better bendability.

Anisotropic dye films are known to exhibit polarizing properties, for example, by alignment of a lyotropic liquid crystal layer that is formed by dissolving dichroic dye molecules containing azo groups in water (see JP 4622434 B, JP 2568882 B, and JP 3492693 B). Anisotropic dye films are known to include dye molecules stacked in a columnar arrangement with the column axis aligned along the alignment regulating force, as disclosed in, for example, JP 4622434 B. Methods utilizing shear stress for alignment of dichroic dye molecules have been studied (see JP 6008031 B and WO 2009/044600).

Also studied are materials of dichroic dye molecules to be aligned with use of alignment films (see JP 2008-69300 A) and alignment films for aligning dichroic dye molecules (see JP 2008-69300 A and JP 2015-163951 A).

### BRIEF SUMMARY OF THE INVENTION

FIG. 5 is a schematic view illustrating a stack composed of dichroic dye molecules. FIG. 6 is a schematic view illustrating the direction of an alignment regulating force of dichroic dye molecules. As generally known, dichroic dye molecules (lyotropic liquid crystal compound) 201M used as a material of a coating-type polarizing plate constitute a columnar stack 201S, and a column axis 201CA of the stack 201S is aligned in an alignment regulating force direction 100F as shown in FIGS. 5 and 6. The alignment regulating force includes shear stress, a magnetic field, and an alignment film. A molecular axis 201MA of each dichroic dye molecule 201M is the absorption axis of the polarizing plate.

Dichroic dye molecules that can be aligned with use of alignment films have less non-uniformity and therefore are expected to be mass-produced, but their alignment is unfortunately unstable. The present inventors made studies to observe a phenomenon that the direction of alignment changed between the center and the periphery of a large substrate under the alignment conditions (alignment film material, alignment method) where dichroic dye molecules on a small substrate of about 5 cm square, for example, were aligned according to an alignment film. Specifically, the column axes were aligned in the direction of the alignment regulating force in the center of the substrate but not in the periphery. The parameter for improving alignment performance is assumed to be different between dichroic dye molecules and conventional liquid crystal molecules for liquid crystal displays. Stable alignment of the column axes of dichroic dye molecules over a large area therefore has been difficult. Accordingly, achievement of uniform polarization properties over a large area has been difficult in a polarizing plate including a polarizing layer in which a lyotropic liquid crystal compound is aligned.

In response to the state of the art, an object of the present invention is to provide a polarizing plate including a polarizing layer that contains a lyotropic liquid crystal compound and capable of achieving uniform polarization properties over a large area, and a display device including the polarizing plate.

(1) One aspect of the present invention is directed to a polarizing plate including: an alignment film; and a polarizing layer on the alignment film, the alignment film containing an alignment film polymer, having a static contact angle with water of 60° or smaller, and having a slow axis, the polarizing layer containing a lyotropic liquid crystal compound and having an absorption axis parallel to the slow axis.

(2) In an embodiment of the present invention, the polarizing plate includes the structure (1), and the lyotropic liquid crystal compound is dichroic.

(3) In an embodiment of the present invention, the polarizing plate includes the structure (1) or (2), and the lyotropic liquid crystal compound has a columnar structure.

(4) In an embodiment of the present invention, the polarizing plate includes the structure (1), (2) or (3), and the alignment film polymer contains an aromatic group.

(5) In an embodiment of the present invention, the polarizing plate includes the structure (1), (2), (3), or (4), and the alignment film polymer contains at least one of a carboxy group or a hydroxy group.

(6) In an embodiment of the present invention, the polarizing plate includes the structure (1), (2), (3), (4), or (5), and the alignment film contains, as the alignment film polymer, a photoalignment film polymer containing a photofunctional group.

(7) In an embodiment of the present invention, the polarizing plate includes the structure (6), and the photoalignment film polymer has a structure represented by the following formula (P-1).

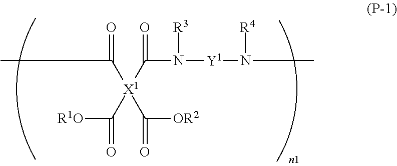

In the formula (P-1), X¹ represents a tetravalent organic group, Y¹ represents a divalent organic group, and at least one of X¹ or Y¹ contains at least one photofunctional group selected from the group consisting of groups obtained by removing at least one hydrogen atom from the structures represented by the following formulas (A-1) to (A-8); R¹, R², R³ and R⁴ each independently represent a hydrogen atom or a monovalent hydrocarbon group; and n1 represents an integer of 1 or larger.

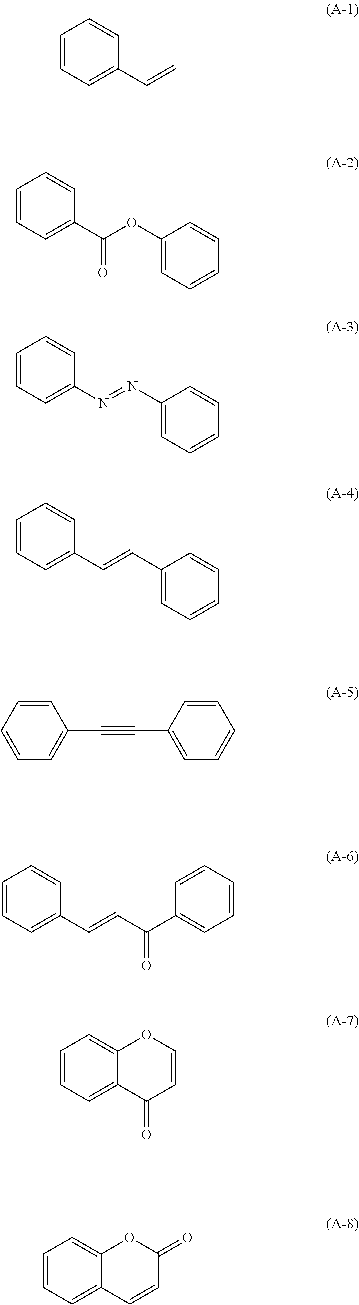

(8) In an embodiment of the present invention, the polarizing plate includes the structure (6), and the photoalignment film polymer has a structure represented by the following formula (P-2).

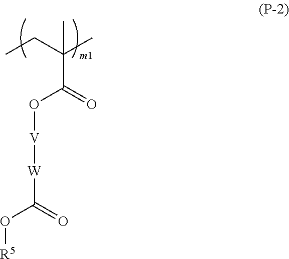

In the formula (P-2), V represents a divalent organic group; W contains at least one photofunctional group selected from the group consisting of groups obtained by removing at least one hydrogen atom from structures represented by the following formulas (A-1) to (A-8); R⁵ represents a monovalent group; and m1 represents an integer of 1 or larger.

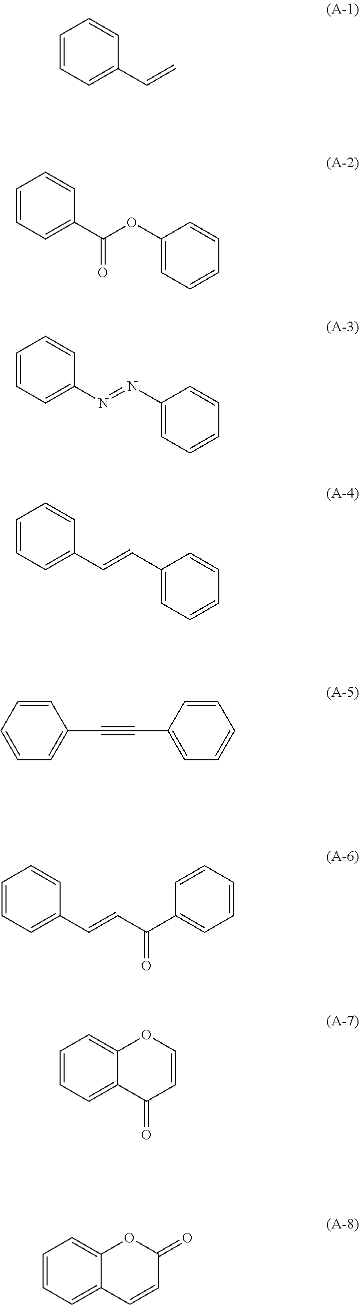

(9) In an embodiment of the present invention, the polarizing plate includes the structure (1), (2), (3), (4), (5), (6), (7), or (8), and the alignment film contains, as the alignment film polymer, at least one photoalignment film polymer selected from the group consisting of a photoisomerization type polymer containing a photofunctional group that isomerizes upon irradiation with light, and a photodimerization type polymer containing a photofunctional group that dimerizes upon irradiation with light.

(10) Another aspect of the present invention is directed to a display device including the polarizing plate according to any one of (1), (2), (3), (4), (5), (6), (7), (8), and (9).

The present invention can provide a polarizing plate including a polarizing layer containing a lyotropic liquid crystal compound and capable of achieving uniform polarization properties over a large area, and a display device including the polarizing plate.

### BRIEF DESCRIPTION OF THE DRAWINGS

FIG. 1 is a schematic cross-sectional view of a polarizing plate of Embodiment 1.

FIG. 2A, FIG. 2B, and FIG. 2C show a chart showing production conditions of alignment films A to Q in examples and comparative examples.

FIG. 3 is a schematic view illustrating an alignment direction a.

FIG. 4 is a schematic view illustrating an alignment direction b.

FIG. 5 is a schematic view illustrating a stack composed of dichroic dye molecules.

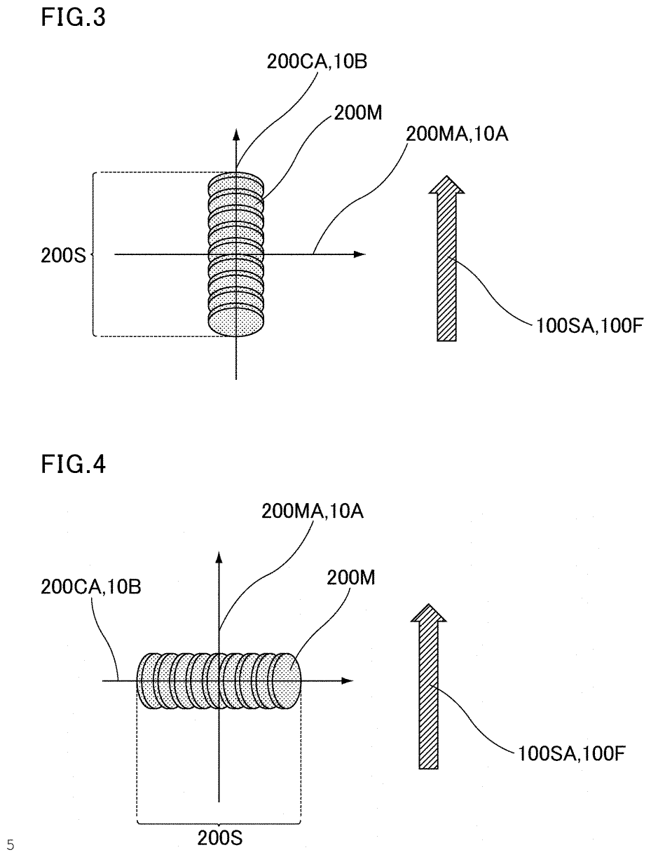

FIG. 6 is a schematic view illustrating an alignment regulating force direction of the dichroic dye molecules.

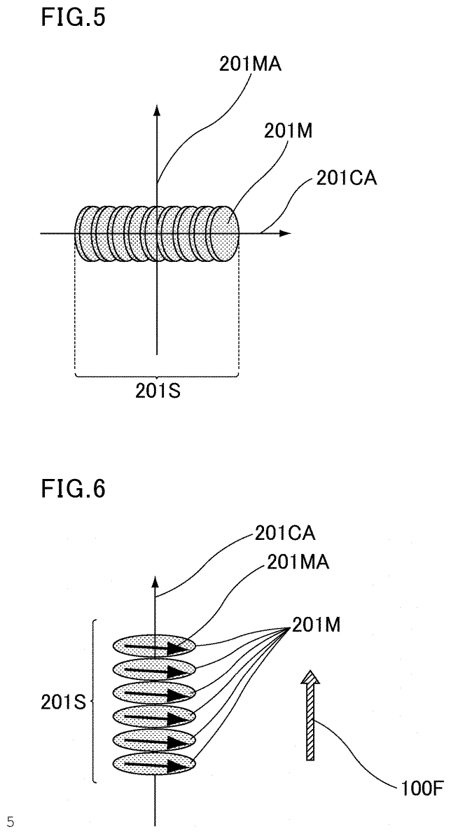

FIG. 7 is a schematic cross-sectional view of a display device of Embodiment 2.

### DETAILED DESCRIPTION OF THE INVENTION

The present invention is described in more detail based on the following Embodiments with reference to the drawings. The Embodiments, however, are not intended to limit the scope of the present invention.

### Embodiment 1

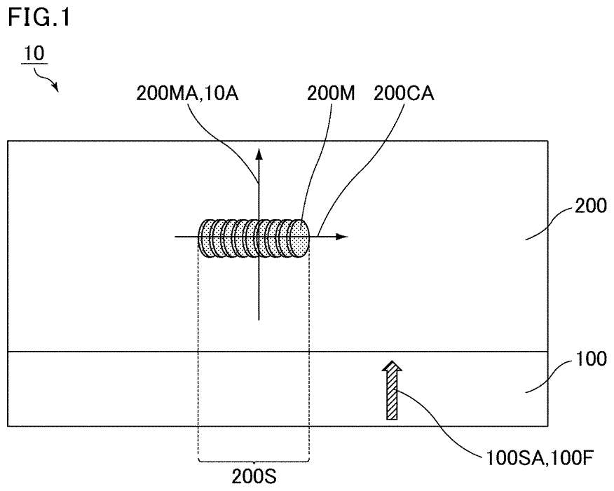

FIG. 1 is a schematic cross-sectional view of a polarizing plate of Embodiment 1. As illustrated in FIG. 1, a polarizing plate 10 of the present embodiment includes an alignment film 100 and a polarizing layer 200 on the alignment film 100. The alignment film 100 contains an alignment film polymer, has a static contact angle with water of 60° or smaller, and has a slow axis 100SA. The polarizing layer 200 contains a lyotropic liquid crystal compound 200M and has an absorption axis 10A parallel to the slow axis 100SA. In such an embodiment, the lyotropic liquid crystal compound 200M can be uniformly aligned over a large area, realizing a polarizing plate 10 having uniform polarization properties over a large area. The term “parallel” herein preferably means that the angle formed by the two axes is 0° (perfect parallel), but the angle has only to be 3° or smaller (substantially parallel). Since the absorption axis of the polarizing layer 200 coincides with the absorption axis of the polarizing plate 10, the absorption axis 10A is the absorption axis of the polarizing layer 200 and also the absorption axis of the polarizing plate 10.

The slow axis 100SA of the alignment film 100 is parallel to a direction 100F in which the alignment regulating force of the alignment film 100 is applied (alignment regulating force direction). A molecular axis 200MA of the lyotropic liquid crystal compound 200M is parallel to the absorption axis 10A of the polarizing plate 10. Specifically, in the present embodiment, the alignment regulating force (the alignment regulating force direction 100F) of the alignment film 100 works on the molecular axis 200MA, not on the column axis 200CA of the lyotropic liquid crystal compound 200M, so that the alignment of the lyotropic liquid crystal compound 200M is stabilized. For the purpose of allowing the alignment regulating force direction 100F to work on the molecular axis 200MA of the lyotropic liquid crystal compound 200M, the alignment film 10 is hydrophilized in the present embodiment. Examples of hydrophilization include excimer UV lamp irradiation, high-pressure mercury lamp irradiation, and ozone treatment.

Here, the function of an alignment film is to make liquid crystal molecules aligned in a specific direction. The alignment treatment causes anisotropy in the refractive index of the film, and the alignment film can also function as a retarder. Therefore, the slow axis of an alignment film refers to the axis along which the phase of transmitted light is delayed, as in the case of a normal retarder.

Non-uniformity may occur when a large polarizing plate is produced using a lyotropic liquid crystal compound. For example, when dichroic dye molecules (lyotropic liquid crystal compound) are aligned using the techniques described in JP 6008031 B and WO 2009/044600, completely controlling the flow caused by coating such as die coating is difficult, and non-uniformity due to environmental factors such as air flow and/or non-uniform coating due to convection and the like cannot be sufficiently suppressed. A polarizing plate having uniform polarization properties over a large area has therefore not been produced.

In JP 2008-69300 A and JP 2015-163951 A, sufficient consideration has not been made on appropriate alignment films. JP 2008-69300 A discloses a rubbed polyimide alignment film and a photoreactive (e.g., photoisomerization, photodimerization, or photodecomposition) alignment film. The present inventors made intensive studies to find out that some rubbed alignment films used to align liquid crystal molecules for liquid crystal displays (DP), such as thermotropic nematic liquid crystal molecules, do not align dichroic dye molecules, and that the common knowledge about conventional alignment films for liquid crystal displays is not applicable.

The present inventors also found out that, though alignment films having an azobenzene structure are generally considered to easily align liquid crystal molecules for liquid crystal displays (e.g., thermotropic nematic liquid crystal molecules), even an alignment film having such an azobenzene structure may not be able to stably align dichroic dye molecules. For example, dichroic dye molecules may be aligned on a substrate in a size of about 5 cm square using an alignment film having an azobenzene structure, but uniform alignment of dichroic dye molecules is difficult on a whole large-sized substrate of a factory mass production size, such as 400 mm×500 mm or larger.

The reason for the unstable alignment may relate to the structure of the dichroic dye molecules. The alignment regulating force commonly acts on the column axis in an anisotropic dye film. The alignment regulating force of alignment films used in conventional liquid crystal displays may be not sufficient to align the column axis, or the alignment direction may be not stable as the regulating force also works on the dichroic dye molecules (especially the molecular axes of the dichroic dye molecules) under certain conditions.

In the present embodiment, an alignment film whose alignment regulating force works on the molecular axis 200MA of the lyotropic liquid crystal compound 200M is used or an alignment treatment that makes the alignment regulating force work on the molecular axis 200MA is performed, which achieves stable alignment of the lyotropic liquid crystal compound 200M even on a large-sized substrate. The polarizing plate 10 of the present embodiment is described in detail below.

The alignment film 100 has a function of controlling the alignment of the lyotropic liquid crystal compound 200M in the polarizing layer 200. The alignment film 100 contains an alignment film polymer. The term “alignment film polymer” refers to any polymer contained in an alignment film. The alignment film 100 may be a photoalignment film subjected to photoalignment treatment as an alignment treatment, a rubbed alignment film subjected to rubbing treatment as an alignment treatment, or an alignment film subjected to no alignment treatment. The photoalignment film contains a photoalignment film polymer containing a photofunctional group as the alignment film polymer.

The alignment film 100 has a static contact angle with water of 60° or smaller. The static contact angle with water is determined, for example, by dropping a 1 μL droplet of water onto a sample surface and measuring the contact angle after one second using a contact angle meter (PCA-1, available from Kyowa Interface Science Co., Ltd.). The static contact angle with water can also be considered as an indicator to quantify the hydrophilicity/hydrophobicity.

An exemplary method of adjusting the static contact angle with water of an alignment film includes introducing a hydrophilic group such as a hydroxy group into a material contained in the alignment film.

The alignment film 100 has a static contact angle with water of 60° or smaller, which allows the alignment regulating force direction 100F of the alignment film 100 to act on the molecular axis 200MA of the lyotropic liquid crystal compound 200M more effectively, leading to more stable alignment of the lyotropic liquid crystal compound 200M. As a result, the polarizing plate 10 having more uniform polarization properties over a large area can be realized. The alignment film 100 preferably has a static contact angle with water of 55° or smaller. In such an embodiment, cissing of the alignment film on the substrate can be reduced, leading to better coating properties. The alignment film 100 more preferably has a static contact angle with water of 50° or smaller.

The alignment film 100 preferably has a static contact angle with water of 35° or larger, more preferably 40° or larger.

The alignment film polymer (e.g., a photoalignment film polymer) preferably contains an aromatic group. In such an embodiment, the alignment regulating force direction 100F of the alignment film 100 can more effectively act on the molecular axis 200MA of the lyotropic liquid crystal compound 200M, leading to more stable alignment of the lyotropic liquid crystal compound 200M. As a result, the polarizing plate 10 having more uniform polarization properties over a large area can be realized.

The alignment film polymer (e.g., a photoalignment film polymer) preferably contains an aliphatic group. In such an embodiment, the aliphatic group in the alignment film 100 is cleaved upon hydrophilization of the alignment film 100, which allows the alignment regulating force direction 100F to work on the molecular axis 200 MA of the lyotropic liquid crystal compound 200M more effectively. As a result, the polarizing plate 10 having more uniform polarization properties over a large area can be realized.

The alignment film polymer (e.g., a photoalignment film polymer) preferably contains at least one of a carboxy group or a hydroxy group. In such an embodiment, the alignment film 100 has higher hydrophilicity, which enables the alignment regulating force direction 100F of the alignment film 100 to work on the molecular axis 200MA of the lyotropic liquid crystal compound 200M more effectively, leading to more stable alignment of the lyotropic liquid crystal compound 200M. As a result, the polarizing plate 10 having more uniform polarization properties over a large area can be realized.

The alignment film 100 preferably contains a photoalignment film polymer containing a photofunctional group as the alignment film polymer. In such an embodiment, the alignment regulating force direction 100F can more effectively work on the molecular axis 200MA of the lyotropic liquid crystal compound 200M, leading to more stable alignment of the lyotropic liquid crystal compound 200M. As a result, the polarizing plate 10 having more uniform polarization properties over a large area can be realized.

The photofunctional group in the photoalignment film polymer means a functional group that may cause photoreactions. The photofunctional group is a functional group that has a structural change such as decomposition (cleavage), rearrangement (preferably photo Fries rearrangement), isomerization, dimerization (dimer formation), or cross-linking, when irradiated with light such as UV or visible light (electromagnetic waves, preferably polarized light, more preferably polarized UV light, particularly preferably linearly polarized UV light), expressing an alignment-regulating force for the lyotropic liquid crystal compound 200M.

Examples of the photofunctional group that degrades upon photoirradiation include cyclobutane ring groups (dianhydride containing a cyclobutane ring such as 1,2,3,4-cyclobutane tetracarboxylic acid 1,2:3,4-dianhydride (CBDA)). Examples of the photofunctional group that undergoes photo Fries rearrangement upon photoirradiation include a phenol ester group (phenol ester structure). Examples of the photofunctional group that dimerizes (crosslinks) and isomerizes upon photoirradiation include a cinnamate group, a chalcone group, a coumarin group, and a stilbene group (cinnamate, cinnamoyl, 4-chalcone, coumarin, stilbene). Examples of the photofunctional group that isomerizes upon photoirradiation include an azobenzene group (azobenzene).

The photoalignment film polymer containing a photofunctional group that decomposes (cleaves) upon photoirradiation is also referred to as a photodecomposition type polymer. The photoalignment film polymer containing a photofunctional group that undergoes rearrangement (preferably photo Fries rearrangement) upon photoirradiation is also referred to as a photorearrangement type polymer (preferably a photo fries rearrangement type polymer). The photoalignment film polymer containing a photofunctional group that isomerizes upon photoirradiation is also referred to as a photoisomerization type polymer. The photoalignment film polymer containing a photofunctional group that dimerizes upon photoirradiation is also referred to as a photodimerization type polymer. The photoalignment film polymer containing a photofunctional group that crosslinks upon photoirradiation is also referred to as a photocrosslinking type polymer.

The alignment film polymer may include one of the following photoalignment film polymers alone: a photodecomposition type polymer; a photorearrangement type polymer; a photoisomerization type polymer; a photodimerization type polymer; and a photocrosslinking type polymer. The alignment film polymer may also include two or more of these photoalignment film polymers.

The alignment film 100 preferably contains, as the alignment film polymer, at least one photoalignment film polymer selected from the group consisting of photoisomerization type polymers and photodimerization type polymers. In such an embodiment, the alignment regulating force direction 100F of the alignment film 100 can more effectively work on the molecular axis 200MA of the lyotropic liquid crystal compound 200M, further stabilizing the alignment of the lyotropic liquid crystal compound 200M. As a result, the polarizing plate 10 having even more uniform polarization properties over a large area can be realized.

The alignment film polymer preferably includes at least one photoalignment film polymer selected from the group consisting of photoisomerization type polymers containing a photofunctional group that contains an aromatic group, photodimerization type polymers containing a photofunctional group that contains an aromatic group, and photocrosslinking type polymers containing a photofunctional group that contains an aromatic group. In such an embodiment, the alignment regulating force direction 100F of the alignment film 100 can more effectively work on the molecular axis 200MA of the lyotropic liquid crystal compound 200M, further stabilizing the alignment of the lyotropic liquid crystal compound 200M. As a result, the polarizing plate 10 having even more uniform polarization properties over a large area can be realized.

The photoalignment film polymer may have any main chain structure. Preferred examples include a polyamic acid structure, a polyimide structure, a poly(meth)acrylic acid structure, a polysiloxane structure, a polyethylene structure, a polystyrene structure, and a polyvinyl structure. From the standpoint of efficiently promoting hydrophilization by excimer UV lamp irradiation or the like, the photoalignment film polymer preferably has a polyamic acid structure, a polyimide structure, or a poly(meth)acrylic acid structure as the main chain structure.

The photoalignment film polymer preferably has a structure represented by the following formula (P-1), for example.

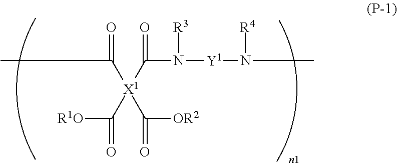

In the formula, X¹ represents a tetravalent organic group, Y¹ represents a divalent organic group, and at least one of X¹ or Y¹ contains at least one photofunctional group selected from the group consisting of groups obtained by removing at least one hydrogen atom from the structures represented by the following formulas (A-1) to (A-8); R¹, R², R³, and R⁴ each independently represent a hydrogen atom or a monovalent hydrocarbon group; and n1 represents an integer of 1 or larger.

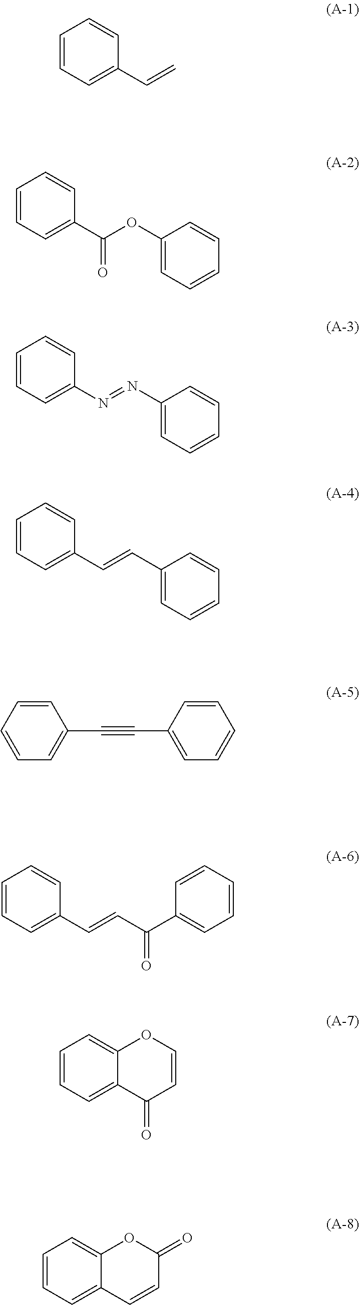

At least one hydrogen atom in each of the above formulas (A-1) to (A-8) may be independently replaced by a halogen atom, a methyl group, or an ethyl group.

In the formula (P-1), when X¹ contains at least one photofunctional group selected from the group consisting of groups obtained by removing at least one hydrogen atom from the structures represented by the following formulas (A-1) to (A-8) (hereafter, also simply referred to as “photofunctional groups represented by the formulas (A-1) to (A-8))”, X¹ may be a group represented by any of the following formulas (AX-2) to (AX-6).

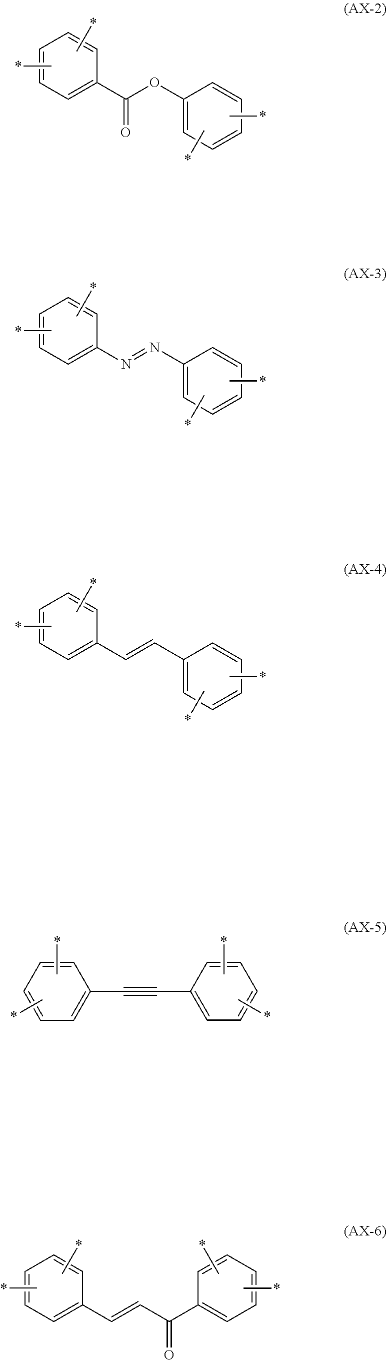

In the formulas, * represents a bonding site.

In the formula (P-1), when X¹ contains a photofunctional group represented by any of the formulas (A-1) to (A-8), X¹ may more specifically be a group represented by any of the following formulas (AX-21) to (AX-25).

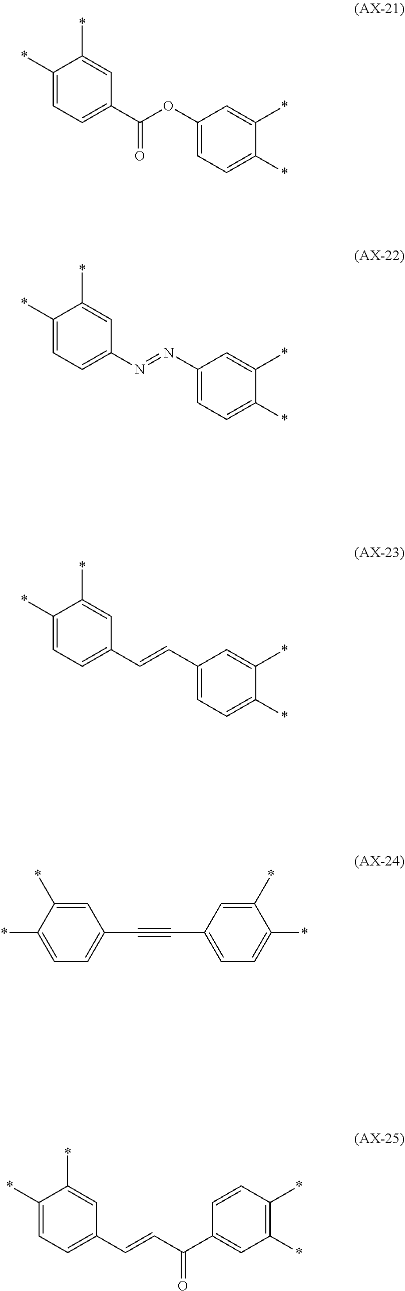 [SMILES: *c1ccc(OC(=O)c2ccc(*)c(*)c2)cc1* ; *c1ccc(/N=N/c2ccc(*)c(*)c2)cc1* ; *c1ccc(/C=C/c2ccc(*)c(*)c2)cc1* ; *c1ccc(C#Cc2ccc(*)c(*)c2)cc1* ; *c1ccc(/C=C/C(=O)c2ccc(*)c(*)c2)cc1*]

In the above formulas, * represents a bonding site.

The symbol “*” in the formulas (AX-2) to (AX-6) and (AX-21) to (AX-25) more specifically represents a bonding site with the —C(═O)— group in the formula (P-1). At least one hydrogen atom in each of the formulas (AX-2) to (AX-6) and (AX-21) to (AX-25) may be independently replaced by a halogen atom, a methyl group, an ethyl group, a COOH group, a COCH₃ group, or a COC₂H₅ group.

In the formula (P-1), when X¹ contains no photofunctional group represented by any of the formulas (A-1) to (A-8), X¹ may be, for example, a C4-C30 tetravalent group containing an alicyclic group, or a C6-C30 tetravalent group containing an aromatic group. More specifically, X¹ may be a group represented by any of the following formulas (BX-1) to (BX-14).

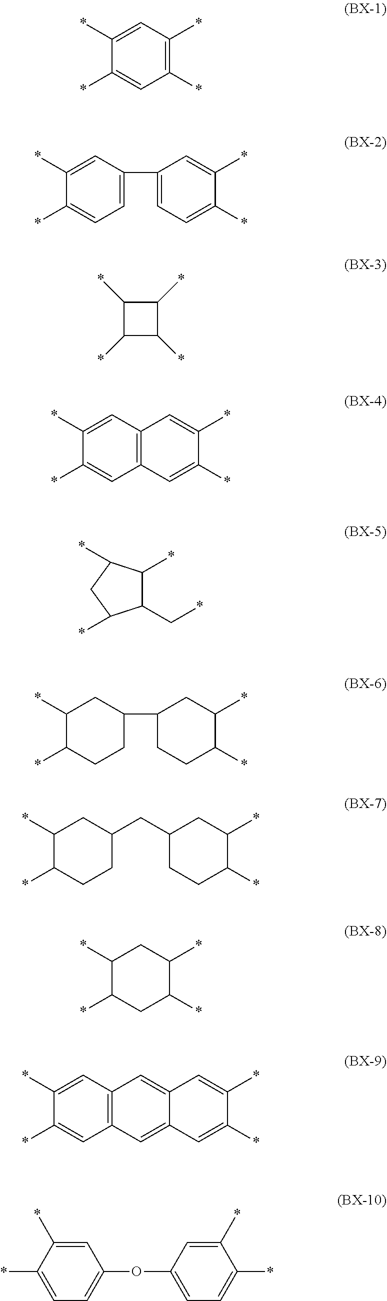

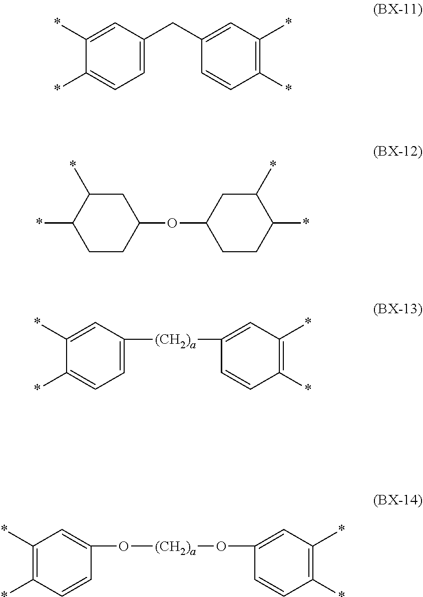

In the formulas, a represents an integer of 2 or larger and 10 or smaller, and * represents a bonding site.

The symbol “*” in the formulas (BX-1) to (BX-14) more specifically represents a bonding site with the —C(═O)— group in the formula (P-1). At least one hydrogen atom in each of the formulas (BX-1) to (BX-14) may be independently replaced by a halogen atom, a methyl group, or an ethyl group.

When Y¹ in the formula (P-1) contains a photofunctional group represented by any of the formulas (A-1) to (A-8), Y¹ may be a group represented by any of the following formulas (AY-1) to (AY-8), for example.

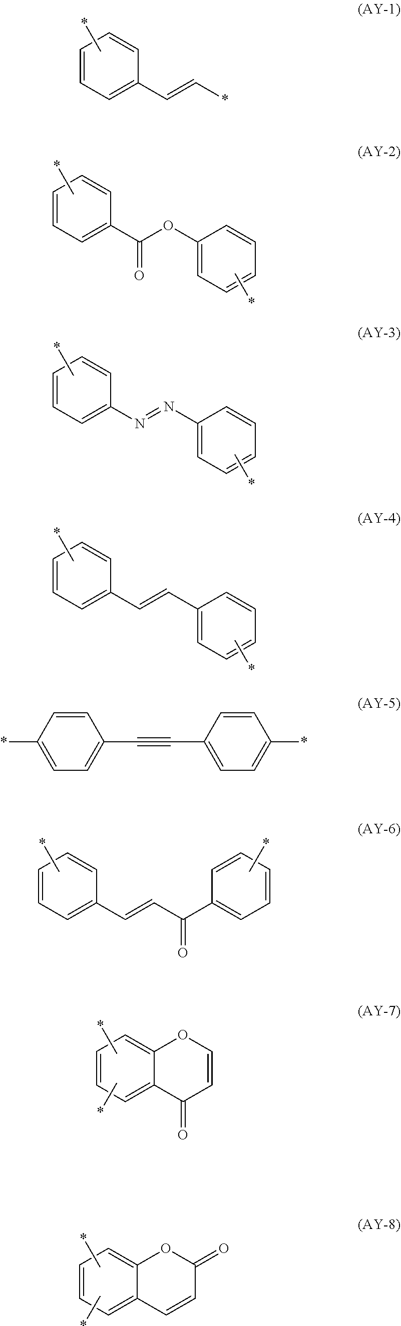

In the formulas, * represents a bonding site.

When Y¹ in the formula (P-1) contains a photofunctional group represented by any of the formulas (A-1) to (A-8), Y¹ may more specifically be a group represented by any of the following formulas (AY-21) to (AY-26).

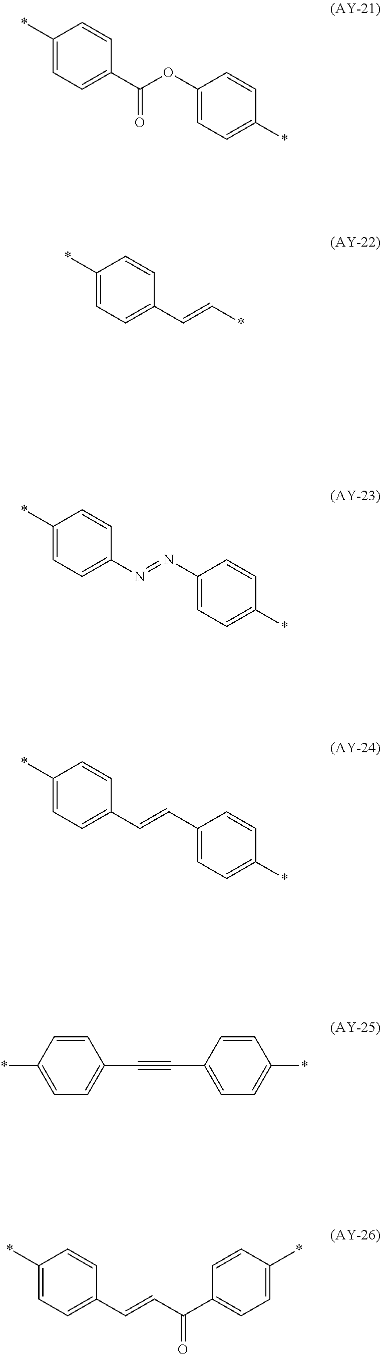 [SMILES: *c1ccc(OC(=O)c2ccc(*)cc2)cc1 ; */C=C/c1ccc(*)cc1 ; *c1ccc(/N=N/c2ccc(*)cc2)cc1 ; *c1ccc(/C=C/c2ccc(*)cc2)cc1 ; *c1ccc(C#Cc2ccc(*)cc2)cc1 ; *c1ccc(/C=C/C(=O)c2ccc(*)cc2)cc1]

In the above formulas, * represents a bonding site.

The symbol “*” in the formulas (AY-1) to (AY-8) and 5 (AY-21) to (AY-26) more specifically represents a bonding site with a —N(R³)— group or N(R⁴)— group in the formula (P-1). At least one hydrogen atom in each of the formulas (AY-1) to (AY-8) and (AY-21) to (AY-26) may be independently replaced by a halogen atom, a methyl group, an ethyl group, a COOH group, a COCH₃ group, or a COC₂H₅ group.

When Y¹ in the formula (P-1) contains no photofunctional group represented by any of the formulas (A-1) to (A-8), Y¹ may be, for example, a C6-C30 tetravalent group containing an aromatic group, more specifically, a group represented by any of the following formulas (BY-1) to (BY-9).

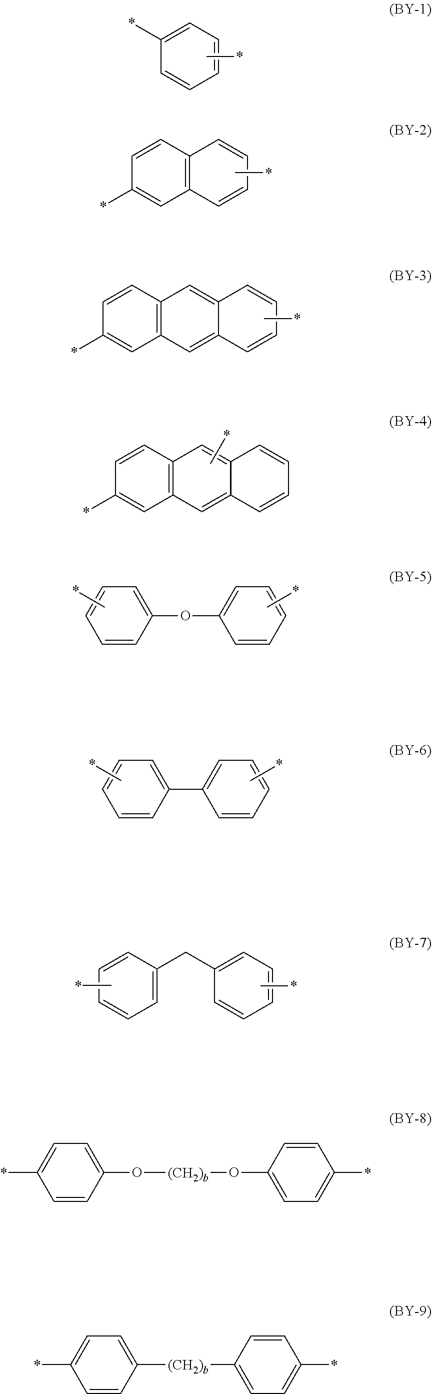

In the formulas, b represents an integer of 2 or larger and 10 or smaller and * represents a bonding site.

The symbol “*” in the formulas (BY-1) to (BY-9) more specifically represents a bonding site with a —N(R³)— group or N(R⁴)— group in the formula (P-1). At least one hydrogen atom in the formulas (BY-1) to (BY-9) may be independently replaced by a halogen atom, a methyl group, or an ethyl group.

The photoalignment film polymer having a structure represented by the formula (P-1) preferably satisfies any of the following conditions 1 to 3.

(Condition 1) In the formula (P-1), X¹ and Y¹ each contain at least one photofunctional group selected from the group consisting of groups obtained by removing at least one hydrogen atom from the structures represented by the formulas (A-1) to (A-8).

(Condition 2) In the formula (P-1), X¹ contains at least one photofunctional group selected from the group consisting of groups obtained by removing at least one hydrogen atom from the structures represented by the formulas (A-1) to (A-8), and Y¹ is a C6-C30 divalent group containing an aromatic group.

(Condition 3) In the formula (P-1), Y¹ contains at least one photofunctional group selected from the group consisting of groups obtained by removing at least one hydrogen atom from the structures represented by the formulas (A-1) to (A-8), and X¹ does not contain the photofunctional group and is a C4-C30 tetravalent group containing an alicyclic group or a C6-C30 tetravalent group containing an aromatic group.

In the formula (P-1), at least one of X¹ or Y¹ preferably contains an alkylene group (—(CH₂)_{c}—) containing two or more carbon atoms. In the above formula, c represents an integer of 2 or larger and 10 or smaller. In such an embodiment, the alignment film 100 can have better alignment order. Since a hydroxy group is generated during hydrophilization (e.g., excimer UV lamp irradiation) of the alignment film 100, the alignment film 100 can be more hydrophilic. As a result, the interaction between the lyotropic liquid crystal compound 200M and the alignment film 100 can be strengthened, leading to improvement of the alignment properties of the liquid crystal compound 200M.

The alkylene group containing two or more carbon atoms may be a linear, branched, or cyclic group, and preferably a linear group. In such an embodiment, the alignment film 100 can exhibit excellent aligning properties.

At least one of X¹ or Y¹ in the formula (P-1) preferably has a phenyl ring structure. In such an embodiment, the alignment film 100 can have better alignment order. Since a hydroxy group is generated during hydrophilization (e.g., excimer UV lamp irradiation) of the alignment film 100, the alignment film 100 can be more hydrophilic. As a result, the interaction between the lyotropic liquid crystal compound 200M and the alignment film 100 can be strengthened, leading to improvement of the alignment properties of the lyotropic liquid crystal compound 200M. Examples of the phenyl ring structure include a phenyl ring structure in any of the formulas (A-1) to (A-6) and a phenyl ring structure in any of the formulas (BX-1), (BX-2), (BX-10), (BX-11), (BX-13), (BX-14), (BY-1), and (BY-5) to (BY-9).

R¹, R², R³, and R⁴ in the formula (P-1) each independently represent a hydrogen atom or a monovalent hydrocarbon group. The monovalent hydrocarbon group is preferably a C1-C20 alkyl group, more preferably a C1-C3 alkyl group, still more preferably a methyl or ethyl group. The alkyl group may have a linear or branched structure.

n1 in the formula (P-1) represents an integer of 1 or larger, and the upper limit of the integer is not limited. Still, the integer may be, for example, 1000 or smaller.

The photoalignment film polymer also preferably has a structure represented by the following formula (P-2).

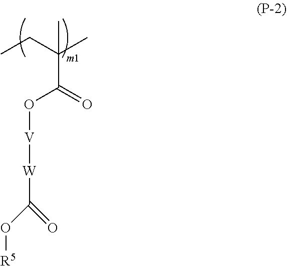

In the formula, V represents a divalent organic group, W represents a divalent organic group containing at least one photofunctional group selected from the group consisting of groups obtained by removing at least one hydrogen atom from the structures represented by the formulas (A-1) to (A-8); R⁵ represents a monovalent group; and m1 represents an integer of 1 or larger.

In the formula (P-2), V is preferably an alkylene group containing two or more carbon atoms. In such an embodiment, the alignment film 100 can have better liquid crystal aligning properties (alignment order). Since a hydroxy group is generated upon hydrophilization (e.g., excimer UV lamp irradiation) of the alignment film 100, the alignment film 100 can be more hydrophilic. As a result, the interaction between the lyotropic liquid crystal compound 200M and the alignment film 100 can be strengthened, leading to improvement of the alignment properties of the lyotropic liquid crystal compound 200M.

The alkylene group containing two or more carbon atoms may be a linear, branched, or cyclic group, and is preferably a linear group. In such an embodiment, the alignment film 100 can exhibit excellent aligning properties.

W in the formula (P-2) represents a divalent organic group containing at least one photofunctional group selected from the group consisting of groups obtained by removing at least one hydrogen atom from the structures represented by the formulas (A-1) to (A-8). W may also be a group represented by any of the following formulas (AW-1) to (AW-8), for example.

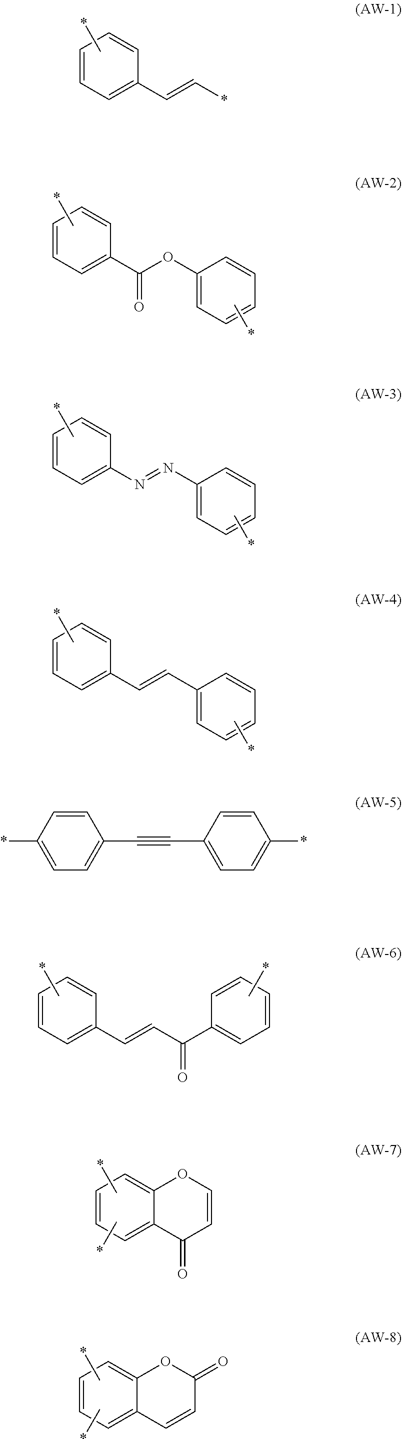

In the formulas, * represents a bonding site.

W may more specifically be a group represented by any of the following formulas (AW-21) to (AW-26).

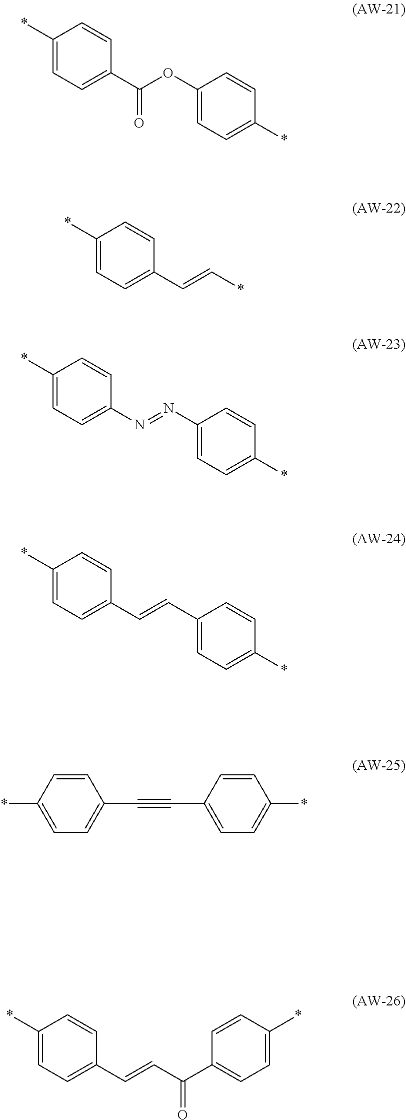

In the formulas, * represents a bonding site.

The symbol “*” in the formulas (AW-1) to (AW-8) and 5 (AW-21) to (AW-26) more specifically represents a bonding site with a —V— group or —COO— group in the formula (P-2). At least one hydrogen atom in any of the formulas (AW-1) to (AW-8) and (AW-21) to (AW-26) may be independently replaced by a halogen atom, a methyl group, or an ethyl group.

R⁵ in the formula (P-2) is preferably a hydrogen atom or a monovalent hydrocarbon group, and is more preferably a hydrogen atom, a methyl group, or an ethyl group.

m1 in the formula (P-2) is an integer of 1 or larger, and the upper limit thereof is not limited. Still, the integer is 5000 or smaller, for example.

Here, the formulas (P-1) and (P-2) each represent a polymer consisting of a single structural unit. Still, the photoalignment film polymer having a structure represented by the formula (P-1) may be a copolymer containing a structural unit (e.g., structural unit containing no photofunctional group) having a structure different from the structure represented by the formula (P-1). Similarly, the photoalignment film polymer having a structure represented by the formula (P-2) may be a copolymer containing a structural unit (e.g., structural unit containing no photofunctional group) having a structure different from the structure represented by the formula (P-2).

The alignment film 100 may also contain a photoalignment film polymer other than the photoalignment film polymer having a structure represented by the formula (P-1). Similarly, the photoalignment film 100 may contain an alignment film polymer other than the photoalignment film polymer having a structure represented by the formula (P-2). In other words, the alignment film 100 may contain two or more alignment film polymers.

The alignment film 100 has a slow axis 100SA. The slow axis 100SA can be measured using, for example, a dual rotating retarder polarimeter (trade name “Axo-scan”, available from Axometrics Inc.) at a wavelength of 550 nm.

The alignment film 100 singly has a retardation in the in-plane uniaxial direction (direction of the slow axis 100SA). In other words, the alignment film 100 has refractive index anisotropy in the in-plane direction. The “retardation” as used herein means an in-plane retardation of 0.5 nm or more to at least light having a wavelength of 550 nm. Light having a wavelength of 550 nm is light of a wavelength at which a human has the highest visual sensitivity. The in-plane retardation is defined as R=(ns−nf)×d, where ns represents the in-plane principal refractive index nx or ny of a retardation layer (alignment film 100), whichever is greater, nf represents the in-plane principal refractive index nx or ny of the retardation layer, whichever is smaller, and d represents the thickness of the retardation layer. The in-plane slow axis of a retardation layer means an axis extending in the direction corresponding to ns, and the in-plane fast axis thereof means an axis extending in the direction corresponding to nf.

The alignment film 100 may have any retardation. The retardation may be 0.5 nm or more and 5 nm or less.

The polarizing layer 200 is provided on the alignment film 100 and contains the lyotropic liquid crystal compound 200M. The Polarizing layer 200 is provided on the upper surface of the alignment film 100, and no other layers are provided between the alignment film 100 and the polarizing layer 200. In other words, the upper surface of the alignment film 100 and the undersurface of the polarizing layer 200 are in contact with each other. The polarizing layer 200 can be obtained, for example, by applying a polarizing ink containing the lyotropic liquid crystal compound 200M and a solvent and drying the applied ink.

The lyotropic liquid crystal compound 200M is a compound that undergoes an isotropic-liquid crystal phase transition (lyotropic liquid crystallinity) when subjected to a temperature or concentration change in the form of a solution dissolved in a solvent. The liquid crystal phase expressed is preferably a phase of rodlike micelles, wormlike micelles, or hexagonal liquid crystals, or a lamellar liquid crystal phase.

The lyotropic liquid crystal compound 200M preferably has a major axis direction and a minor axis direction. The lyotropic liquid crystal compound 200M is preferably dichroic. Dichroism is a property where the absorbance in the major axis direction of the molecule is different from the absorbance in the minor axis direction of the molecule.

The lyotropic liquid crystal compound 200M preferably constitutes a columnar stack 200S. In other words, the lyotropic liquid crystal compound 200M preferably has a columnar structure. The lyotropic liquid crystal compound 200M is thought to have a property of forming a columnar structure on its own and being aligned in a manner that the column axis is parallel to the alignment regulating force direction. The lyotropic liquid crystal compound 200M has, for example, a disk-shaped structure, and the columnar structure is established by stacking multiple disk-shaped molecules of the lyotropic liquid crystal compound 200M in a manner that the molecules overlap with each other at or around the centers thereof. The column axis is an axis extending through the center of the multiple molecules of the lyotropic liquid crystal compound 200M forming the columnar structure.

Examples of the lyotropic liquid crystal compound 200M include azo compounds, anthraquinone compounds, perylene compounds, quinophthalone compounds, naphthoquinone compounds, and merocyanine compounds. Azo compounds are preferred because they exhibit good lyotropic liquid crystallinity.

Among azo compounds, preferred are azo compounds containing an aromatic ring in the molecule, and more preferred are disazo compounds containing a naphthalene ring in the molecule. Application of a polarizing ink containing such an azo compound and subsequent drying thereof can provide a polarizing layer 200 with excellent polarizing properties.

The azo compound is preferably an azo compound containing a polar group in the molecule. An azo compound containing a polar group is soluble in a polar solvent and easily dissolves in a polar solvent to form a columnar structure. A polarizing ink containing an azo compound containing a polar group therefore exhibits particularly good lyotropic liquid crystallinity. The “polar group” means a functional group having polarity. Examples of the polar group include oxygen and/or nitrogen-containing functional groups having relatively high electronegativity such as an OH group, a COOH group, a NH₂ group, a NO₂ group, and a CN group.

The azo compound containing a polar group is preferably, for example, an aromatic disazo compound represented by the following formula (L1).

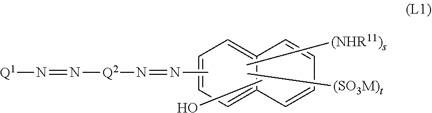

In the formula (L1), Q¹ represents a substituted or unsubstituted aryl group; Q² represents a substituted or unsubstituted arylene group; R¹¹s each independently represent a hydrogen atom, a substituted or unsubstituted alkyl group, a substituted or unsubstituted acetyl group, a substituted or unsubstituted benzoyl group, or a substituted or unsubstituted phenyl group; M represents a counter ion; s represents an integer of 0 to 2; and t represents an integer of 0 to 6. At least one of s or t is not zero and 1≤s+t≤6 is satisfied. When s is 2, R¹¹s are the same as or different from each other. OH, (NHR¹¹)s, and (SO₃M)t each may be bound to any of seven substitution sites of the naphthyl ring. The phrase “substituted or unsubstituted” as used herein means “replaced by a substituent or not replaced by a substituent”.

The bonding position of the naphthyl group and the azo group (—N═N—) in the formula (L1) is not limited. The above naphthyl group refers to the naphthyl group on the right side in the formula (L1). Preferably, the naphthyl group and the azo group are bound to each other at the position 1 or position 2 of the naphthyl group.

When the alkyl, acetyl, benzoyl, or phenyl group as R¹¹ in the formula (L1) has a substituent, examples of the substituent include the substituents exemplified for the aryl or arylene group below. R¹¹ is preferably a hydrogen atom, a substituted or unsubstituted alkyl group, or a substituted or unsubstituted acetyl group, more preferably a hydrogen atom. Examples of the substituted or unsubstituted alkyl group include substituted or unsubstituted C1-C6 alkyl groups.

M (counter ion) in the formula (L1) is preferably a hydrogen ion; an alkali metal ion such as Li, Na, K, Cs; an alkaline earth metal ion such as Ca, Sr, Ba; another metal ion; an ammonium ion optionally replaced by an alkyl or hydroxyalkyl group; or a salt of an organic amine. Examples of the metal ion include Ni⁺, Fe³⁺, Cu²⁺, Ag⁺, Zn²⁺, Al³⁺, Pd²⁺, Cd²⁺, Sn²⁺, Co²⁺, Mn²⁺, and Ce³⁺. Examples of the organic amine include C1-C6 alkyl amines, C1-C6 alkyl amines containing hydroxy groups, and C1-C6 alkyl amines containing carboxy groups. When two or more SO₃M are present in the formula (L1), Ms may be the same as or different from each other.

s in the formula (L1) is preferably 1. t in the formula (L1) is preferably 1 or 2. Specific examples of the naphthyl group in the formula (L1) include groups represented by the following formulas (LA1) to (LA12). R¹¹ and M in the formulas (LA1) to (LA12) are the same as those in the formula (L1).

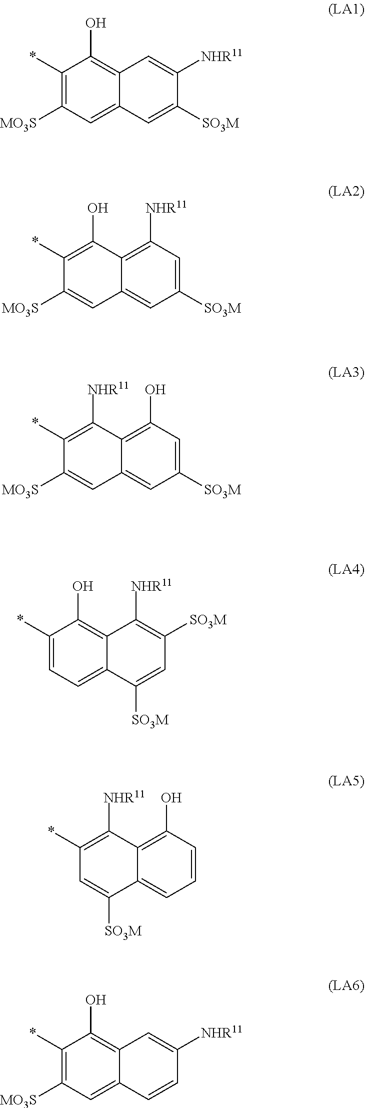

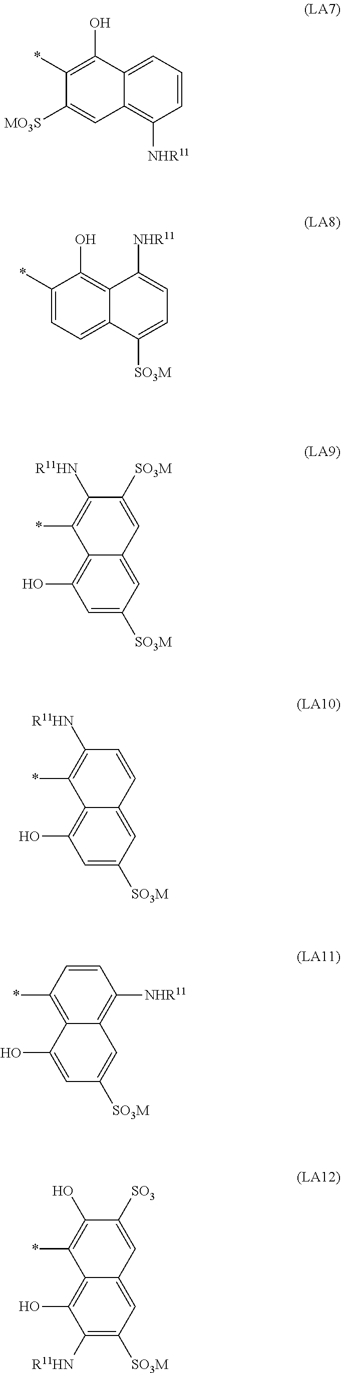

In the formulas, * represents a bonding site.

The symbol “*” in the above formulas (LA1) to (LA12) more specifically represents a bonding site with the azo group.

In the formula (L1), examples of the aryl group as Q¹ include not only a phenyl group but also a fused ring group consisting of two or more fused benzene rings such as a naphthyl group. Examples of the arylene group as Q² include not only a phenylene group but also a fused ring group with two or more fused benzene rings such as a naphthylene group.

The aryl group as Q¹ and the arylene group as Q² each may or may not have a substituent. Whether the aryl or arylene group is substituted or unsubstituted, the aromatic disazo compound containing a polar group of the formula (L1) has excellent solubility in a polar solvent.

When the aryl or arylene group has a substituent, examples of the substituent include C1-C6 alkyl groups, C1-C6 alkoxy groups, C1-C6 alkylamino groups, a phenylamino group, C1-C6 acylamino groups, C1-C6 hydroxyalkyl groups such as a dihydroxypropyl group, carboxy groups such as a COOM group, sulfonic acid groups such as a SO₃M group, a hydroxy group, a cyano group, a nitro group, an amino group, and a halogeno group. Preferably, the substituent is one selected from a C1-C6 alkoxy group, a C1-C6 hydroxyalkyl group, a carboxy group, a sulfonic acid group, and a nitro group. An aromatic disazo compound with such a substituent has particularly excellent solubility in a polar solvent. One or more of these substituents may be introduced. The substituents may be introduced at any ratio.

Q¹ in the formula (L1) is preferably a substituted or unsubstituted phenyl group, more preferably a phenyl group with any of the substituents. Q² is preferably a substituted or unsubstituted naphthylene group, more preferably a naphthylene group with any of the substituents, particularly preferably a 1,4-naphthylene group with any of the substituents.

The aromatic disazo compound represented by the formula (L1) wherein Q¹ represents a substituted or unsubstituted phenyl group and Q² represents a substituted or unsubstituted 1,4-naphthylene group is represented by the following formula (L2).

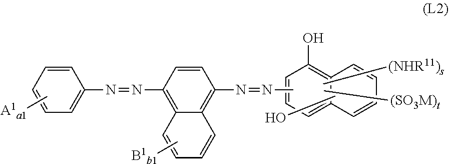

In the formula (L2), R¹¹, M, s, and t are the same as those in the formula (L1). In the formula (L2), A¹ and B¹ each represent a substituent, and a1 and b1 each represent the number of substitutions. A¹ and B¹ each independently represent a C1-C6 alkyl group, a C1-C6 alkoxy group, a C1-C6 alkylamino group, a phenylamino group, a C1-C6 acylamino group, a C1-C6 hydroxyalkyl group such as a dihydroxypropyl group, a carboxy group such as a COOM group, a sulfonic acid group such as a SO₃M group, a hydroxy group, a cyano group, a nitro group, an amino group, or a halogeno group. a1 represents an integer of 0 to 5, and b1 represents an integer of 0 to 4. At least one of a1 or b1 is not zero. When a1 is 2 or more, the substituents A¹ may be the same as or different from each other. When b1 is 2 or more, the substituents B¹ may be the same as or different from each other.

Among the aromatic disazo compounds represented by the formula (L2), an aromatic disazo compound represented by the following formula (L3) is preferred. The aromatic disazo compound of the formula (L3) has a substituent A¹ bound at the para position with respect to the azo group (—N═N—). Also, the aromatic disazo compound of the formula (L3) has the OH group of its naphthyl group bound at a position adjacent to the azo group (ortho position). Use of such an aromatic disazo compound of the formula (L3) can provide a polarizing plate with a high degree of polarization.

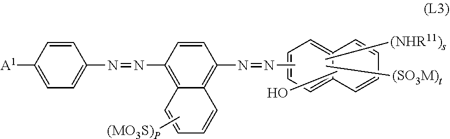

In the formula (L3), R¹¹, M, m, and n are the same as those in the formula (L1), and A¹ is the same as that in the formula (L2). In the formula (L3), p represents an integer of 0 to 4. p is preferably 1 or 2, more preferably 1.

The aromatic disazo compounds represented by the formulas (L1) to (L3) can be synthesized in accordance with, for example, Hosoda, Yutaka. Riron-seizo, Senryo-kagaku (Theoretical Manufacturing: Dye Chemistry), 5th Edition, Giho-do, Jul. 15, 1968, pp. 135-152). For example, the aromatic disazo compound of the formula (L3) can be synthesized as follows. An aniline derivative and a naphthalenesulfonic acid derivative are diazotized and coupled, thereby preparing a monoazo compound. The monoazo compound is diazotized and then coupled with a 1-amino-8-naphtholsulfonic acid derivative.

The absorption axis 10A of the polarizing plate 10 is parallel to the slow axis 100SA of the alignment film 100. The absorption axis 10A of the polarizing plate 10 is parallel to the molecular axis 200MA of the lyotropic liquid crystal compound 200M. Here, the molecular axis 200MA of the lyotropic liquid crystal compound 200M means the major axis direction of the lyotropic liquid crystal compound 200M, for example.

As illustrated in FIG. 1, the polarizing plate 10 of the present embodiment includes the alignment film 100 and the polarizing layer 200 on the upper surface of the alignment film 100. The structure of the polarizing plate 10 is not limited to this structure. The polarizing plate 10 may include a protective layer on the upper surface of the polarizing layer 200 and/or a substrate on the undersurface of the alignment film 100. When a protective layer is stacked on the upper surface of the polarizing layer 200, any suitable adhesive layer may be provided between the protective layer and the polarizing layer 200.

Next, an example of a production method of the polarizing plate 10 will be described. A production method of the polarizing plate 10 sequentially includes a polymer layer forming step, an irradiation step, a hydrophilization step, and a polarizing layer forming step. The polymer layer forming step includes forming a polymer layer containing at least one photoalignment film polymer selected from the group consisting of a photoisomerization polymer containing a photofunctional group that isomerizes upon photoirradiation and a photodimerization polymer containing a photofunctional group that dimerizes upon photoirradiation. The irradiation step includes photoirradiating the polymer layer to form a photoalignment film. The hydrophilization step includes hydropholizing the photoalignment film. The polarizing layer forming step includes forming the polarizing layer 200 containing the lyotropic liquid crystalline compound 200M on the photoalignment film.

In the polymer layer forming step, the polymer layer containing at least one photoalignment film polymer is formed. In the polymer layer forming step, for example, an alignment film material containing at least one photoalignment film polymer is applied to a substrate. The substrate is preferably a transparent substrate such as a glass substrate or a plastic substrate. The application method is not limited, and examples thereof include spin coating, inkjet printing, and offset printing. The polarizing plate 10 including no substrate can be obtained by removing a stack including the alignment film 100 and the polarizing layer 200 from a substrate of the polarizing plate 10 including the substrate, the alignment film 100 provided on the upper surface of the substrate, and the polarizing layer 200 provided on the upper surface of the alignment film 100.

In the irradiation step, the photoalignment film polymer applied to the substrate is irradiated with light to form the photoalignment film. Examples of the light irradiated to the photoalignment film polymer include light such as UV light and visible light (electromagnetic waves, preferably polarized light, more preferably polarized UV light, particularly preferably linearly polarized UV light).

A post-baking step may be provided between the irradiation step and the hydrophilization step. In the post-baking step, the photoalignment film formed in the irradiation step is heated. The post-baking step is carried out using a heating device such as a hot plate or a hot air circulating furnace set to a predetermined temperature, for example.

In the hydrophilization step, the photoalignment film is hydrophilized. In the hydrophilization step, at least one of the following treatments is performed on the photoalignment film: excimer UV lamp irradiation; high-pressure mercury lamp irradiation; and ozone treatment.

In the polarizing layer forming step, the polarizing layer 200 containing the lyotropic liquid crystal compound 200M is formed on the photoalignment film. In the polarizing layer forming step, the polarizing layer 200 is formed, for example, by applying a polarizing ink containing the lyotropic liquid crystal compound 200M to the photoalignment film. The lyotropic liquid crystal compound 200M contained in the polarizing ink is aligned in a predetermined direction under the influence of the alignment regulating force of the alignment film 100. The alignment of the lyotropic liquid crystal compound 200M is fixed by drying the polarizing ink. Thus, the polarizing layer 200 having polarization properties is formed on the alignment film 100. The application method of the polarizing ink is not limited, and examples thereof include spin coating, inkjet printing, and offset printing.

### Embodiment 2

In the present embodiment, features specific to the present embodiment are mainly described, and a description duplicated with Embodiment 1 is omitted. In the present embodiment, a display device including the polarizing plate 10 of Embodiment 1 is described.

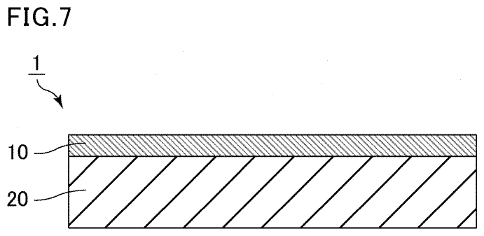

FIG. 7 is a schematic cross-sectional view of a display device of Embodiment 2. As illustrated in FIG. 7, a display device 1 of the present embodiment includes the polarizing plate 10 and a display panel 20. Examples of the display panel 20 include an organic electroluminescent display panel and a liquid crystal display panel. The polarizing plate 10 includes the polarizing layer 200 containing a lyotropic liquid crystal compound, and therefore has better heat resistance and is thinner than a PVA iodine polarizing plate, leading to higher bendability. The polarizing plate 10 has uniform polarization properties over a large area, as described above. The display device 1 therefore can achieve flexibility and a large area.

The display device 1 includes, for example, the polarizing plate 10 and a 2/4 retardation layer on the observation side of the display panel 20. The in-plane slow axis of the 2/4 retardation layer and the absorption axis of the polarizing plate 10 preferably form an angle of substantially 45°. In such a case, the 2/4 retardation layer functions as a circular polarizing plate in combination with the polarizing plate 10. This can reduce internal reflection of the display device 1, thus suppressing external light reflection (glare). Therefore, high-contrast displays can be produced even in a bright environment with strong ambient light.

The present invention is described in more detail below based on examples and comparative examples. The examples, however, are not intended to limit the scope of the present invention.

### Comparative Example 1

An azo polyimide isomerization type photoalignment film material X (hereinafter, also referred to as an alignment film material X) was applied to a 5 cm×5 cm bare glass (glass substrate) by spin coating, and polarized light exposure was performed with the exposure amount set to the same as normal conditions for liquid crystal display liquid crystals, followed by post-baking. Thus, an alignment film A was formed on the substrate. The static contact angle with water of the alignment film A and the retardation of the alignment film A were determined. The static contact angle with water was determined as follows. A 1 μL droplet of water was dropped onto the surface of the alignment film, and the contact angle after one second was measured using a contact angle meter (PCA-1, available from Kyowa Interface Science Co., Ltd.). The measurement was performed five times, and the average of the measurements was calculated as the static contact angle with water. The retardation was measured using “Axo Scan FAA-3 series” available from Axo Metrics at a wavelength of 550 nm.

The alignment film material X contained: a photoalignment film polymer represented by the formula (P-1) wherein X¹ represents a tetravalent C6 organic group having an alkylene chain structure, Y¹ represents a divalent organic group containing a photofunctional group (a group containing an azobenzene structure) obtained by removing at least one hydrogen atom from the structure represented by the formula (A-4); N-methyl-2-pyrrolidone (NMP); and butyl cellosolve (BC) blended at a mass ratio (a resin component containing the photoalignment polymer (solid content)/NMP/BC) of 6/64/30.

Next, a polarizing ink containing a lyotropic liquid crystal compound was applied to the alignment film A by spin coating to form a polarizing layer. The polarizing layer was dried naturally. Thus, a polarizing plate of Comparative Example 1 was obtained.

### Comparative Example 2

A polarizing plate of Comparative Example 2 was obtained as in Comparative Example 1, except that the alignment film material X applied to the glass substrate was hydrophilized, before polarized light exposure, by irradiation with light of about 300 mJ/cm² using an excimer UV lamp (product name: UEM 110L-172, available from Ushio Inc.) including an Xe light source with a central wavelength of 172 nm, and then subjected to post-baking to form an alignment film B. After formation of the alignment film B and before formation of the polarizing layer, the static contact angle with water of the alignment film B was measured as in Comparative Example 1. The retardation of the alignment film B was measured as in Comparative Example 1.

### Example 1

A polarizing plate of Example 1 was obtained as in Comparative Example 1, except that the alignment film was hydrophilized, after post-baking, by excimer UV lamp irradiation under the same conditions as in Comparative Example 2 to form an alignment film C. After formation of the alignment film C and before formation of the polarizing layer, the static contact angle with water of the alignment film C was measured as in Comparative Example 1. The retardation of the alignment film C was measured as in Comparative Example 1.

### Comparative Example 3

A polarizing plate of Comparative Example 3 was obtained as in Comparative Example 1, except that the exposure amount was changed to 1/20 of the amount in Comparative example 1 to form an alignment film D. After formation of the alignment film D and before formation of the polarizing layer, the static contact angle with water of the alignment film D was measured as in Comparative Example 1. The retardation of the alignment film D was measured as in Comparative Example 1.

### Comparative Example 4

A polarizing plate of Comparative Example 4 was obtained as in Comparative Example 3, except that the alignment film material X applied to the glass substrate was hydrophilized, before polarized light exposure, by excimer UV lamp irradiation under the same conditions as in Comparative example 2, and then subjected to post-baking to form an alignment film E. After formation of the alignment film E and before formation of the polarizing layer, the static contact angle with water of the alignment film E was measured as in Comparative Example 1. The retardation of the alignment film E was measured as in Comparative Example 1.

### Example 2

A polarizing plate of Example 2 was obtained as in Comparative Example 3, except that the alignment film was hydrophilized, after post-baking, by excimer UV lamp irradiation under the same conditions as in Comparative Example 2 to form an alignment film F. After formation of the alignment film F and before formation of the polarizing layer, the static contact angle with water of the alignment film F was measured as in Comparative Example 1. The retardation of the alignment film F was measured as in Comparative Example 1.

### Comparative Example 5

A dimerization and isomerization type alignment film material Y containing an aromatic group (hereafter, also referred to as an alignment film material Y) was applied to a 5 cm×5 cm bare glass (glass substrate) by spin coating, and polarized light exposure was performed with the exposure amount set to the same as normal conditions for liquid crystal display liquid crystals, followed by post-baking. Thus, an alignment film G was formed on the substrate. The static contact angle with water of the alignment film G was measured as in Comparative Example 1. The retardation of the alignment film G was measured as in Comparative Example 1.

The alignment film material Y contained: a photoalignment film polymer represented by the formula (P-2) wherein V contains a C6 alkylene group and W represents a divalent organic group containing a photofunctioal group (group containing a cinnamoyl structure (cinnamate group)) obtained by removing at least one hydrogen atom from the structure represented by the formula (A-1); NMP; and BC, blended at a mass ratio (a resin component containing the photoalignment film polymer (solid content)/NMP/BC) of 6/64/30.

Next, a polarizing ink containing the same lyotropic liquid crystal compound as in Comparative Example 1 was applied to the alignment film G by spin coating to form a polarizing layer. The polarizing layer was dried naturally. Thus, a polarizing plate of Comparative Example 5 was obtained.

### Comparative Example 6

A polarizing plate of Comparative Example 6 was obtained as in Comparative Example 5, except that the alignment film material Y applied to the glass substrate was hydrophilized, before polarized light exposure, by excimer UV lamp irradiation under the same conditions as in Comparative Example 2, and then subjected to post-baking to form an alignment film H. After formation of the alignment film H and before formation of the polarizing layer, the static contact angle with water of the alignment film H was measured as in Comparative Example 1. The retardation of the alignment film H was measured as in Comparative Example 1.

### Example 3

A polarizing plate of Example 3 was obtained as in Comparative Example 5, except that the alignment film was hydrophilized, after post-baking, by excimer UV lamp irradiation under the same conditions as in Comparative Example 2 to form an alignment film I. After formation of the alignment film I and before formation of the polarizing layer, the static contact angle with water of the alignment film I was measured as in Comparative Example 1. The retardation of the alignment film I was measured as in Comparative Example 1.

### Comparative Example 7

A degradable photoalignment film material Z containing no aromatic group (hereafter, also referred to as an “alignment film material Z”) was applied to a 5 cm×5 cm bare glass (glass substrate) by spin coating. The applied alignment film material Z was subjected to polarized light exposure with the exposure amount set to the same as the normal conditions for liquid crystal display liquid crystals (excimer UV lamp irradiation under the same conditions as in Comparative Example 2), followed by post-baking. Thus, an alignment film J was formed on the substrate. The static contact angle with water of the alignment film J was measured as in Comparative Example 1.

The alignment film material Z contained: an alignment film polymer composed of a polyamic acid represented by the formula (P-1) wherein X¹ represents a tetravalent organic group containing a cyclobutane ring as a photofunctional group and Y¹ represents a divalent organic group having a structure represented by the formula (BY-1); NMP; and BC, blended at a mass ratio (a resin component containing the alignment film polymer (solid content)/NMP/BC) of 6/64/30. The alignment film polymer composed of the polyamic acid in the alignment film material Z did not have any of the structures represented by the formulas (A-1) to (A-8).

Next, a polarizing ink containing the same lyotropic liquid crystal compound as in Comparative Example 1 was applied to the alignment film J by spin coating to form a polarizing layer. The polarizing layer was dried naturally. Thus, a polarizing plate of Comparative Example 7 was obtained.

### Comparative Example 8

A polarizing plate of Comparative Example 8 was obtained as in Comparative Example 7, except that the alignment film was hydrophilized, after post-baking, by excimer UV lamp irradiation under the same conditions as in Comparative Example 2 to form an alignment film K. After formation of the alignment film K and before formation of the polarizing layer, the static contact angle with water of the alignment film K was measured as in Comparative Example 1.

### Comparative Example 9

An alignment film material U containing an aliphatic group (hereafter, also referred to as an alignment film material U) was applied to a 5 cm×5 cm bare glass (glass substrate) by spin coating, followed by rubbing with a rayon cloth at an amount of indentation of 0.4 mm and a speed of 15 mm/s. Thus, an alignment film L was formed. The static contact angle with water of the alignment film L was measured as in Comparative Example 1.

The alignment film material U contained: an alignment film polymer composed of a polyamic acid represented by the formula (P-1) wherein X¹ represents a tetravalent organic group containing a cyclobutane ring and Y¹ represents a divalent organic group having a structure represented by the formula (BY-1); NMP; and BC, blended at a mass ratio (a resin component containing the alignment film polymer (solid content)/NMP/BC) of 6/64/30. The alignment film polymer composed of the polyamic acid in the alignment film material U did not have a structure represented by any of the formulas (A-1) to (A-8).

Next, a polarizing ink containing the same lyotropic liquid crystal compound as in Comparative Example 1 was applied to the alignment film L by spin coating to form a polarizing layer. The polarizing layer was then dried naturally. Thus, a polarizing plate of Comparative Example 9 was obtained.

### Comparative Example 10

A polarizing plate of Comparative Example 10 was obtained as in Comparative Example 9, except that the alignment film was hydrophilized, after rubbing, by excimer UV lamp irradiation under the same conditions as in Comparative Example 2 to form an alignment film M. After formation of the alignment film M and before formation of the polarizing layer, the static contact angle with water of the alignment film M was measured as in Comparative Example 1.

### Comparative Example 11

An alignment film material V containing an aromatic group (hereafter, also referred to as an alignment film material V) was applied to a 5 cm×5 cm bare glass (glass substrate) by spin coating, followed by rubbing with a rayon cloth at an amount of indentation of 0.4 mm and a speed of 15 mm/s. Thus, an alignment film N was formed. The static contact angle with water of the alignment film N was measured as in Comparative Example 1.

The alignment film material V contained: an alignment film polymer composed of a polyamic acid represented by the formula (P-1) wherein X¹ represents a tetravalent organic group containing a phenyl ring and Y¹ represents a divalent organic group having a structure represented by the formula (BY-1); NMP; and BC, blended at a mass ratio (a resin component containing the alignment film polymer (solid content)/NMP/BC) of 6/64/30. The alignment film polymer composed of the polyamic acid in the alignment film material V did not have a structure represented by any of the above formulas (A-1) to (A-8).

Next, a polarizing ink containing the same lyotropic liquid crystal compound as in Comparative Example 1 was applied to the alignment film N by spin coating to form a polarizing layer. The polarizing layer was then dried naturally. Thus, a polarizing plate of Comparative Example 11 was obtained.

### Comparative Example 12

A polarizing plate of Comparative Example 12 was obtained as in Comparative Example 11, except that the alignment film was hydrophilized, after rubbing, by excimer UV lamp irradiation under the same conditions as in Comparative Example 2 to form an alignment film O. After formation of the alignment film O and before formation of the polarizing layer, the static contact angle with water of the alignment film O was measured as in Comparative Example 1.

### Comparative Example 13

The alignment film material X was applied to a 5 cm×5 cm bare glass (glass substrate) by spin coating, followed by rubbing. Thus, an alignment film P was formed.

Next, a polarizing ink containing the same lyotropic liquid crystal compound as in Comparative Example 1 was applied to the alignment film P by spin coating to form a polarizing layer. The polarizing layer was then dried naturally. Thus, a polarizing plate of Comparative Example 13 was obtained.

### Comparative Example 14

A polarizing plate of Comparative Example 14 was obtained as in Comparative Example 13, except that the alignment film was hydrophilized, after rubbing, by excimer UV lamp irradiation under the same conditions as in Comparative Example 2 to form an alignment film Q.

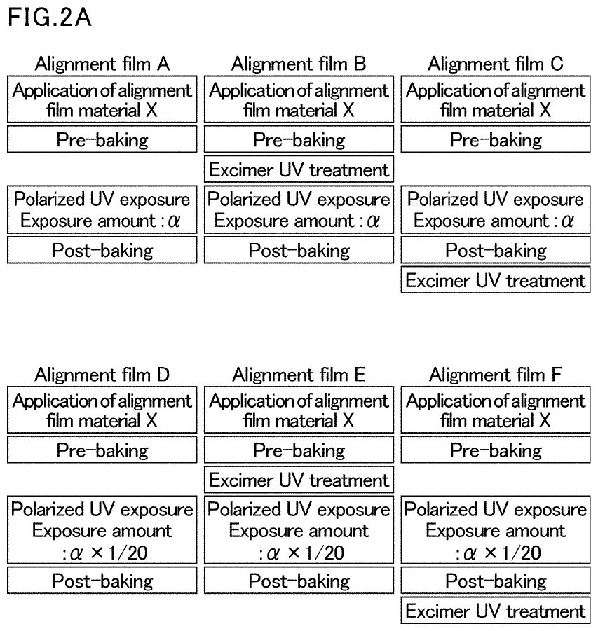

FIG. 2A, FIG. 2B, and FIG. 2C show a chart showing production conditions of the alignment films A to Q in the examples and comparative examples. The production conditions of the alignment films A to Q produced as above in the examples and comparative examples are shown in FIG. 2A, FIG. 2B, and FIG. 2C.

### (Evaluation (Small Size Test) of Examples 1 to 3 and Comparative Examples 1 to 14)

The optical properties of the polarizing plates of Examples 1 to 3 and Comparative Examples 1 to 14 were evaluated as follows.

The parallel transmittance (Tp) and crossed transmittance (Tc) were measured for each of the polarizing plates of Examples 1 to 3 and Comparative Examples 1 to 14. Based on the measurements, the single transmittance Ts=(Tp+Tc)/2 and the contrast ratio CR=Tp/Tc were calculated. Tp was obtained as follows. The spectral transmittance in a parallel Nicols state was measured in the wavelength range of 380 to 780 nm using a UV-visible spectrophotometer (trade name: V7100, available from JASCO Corporation), followed by relative spectral responsivity correction assuming the field of view of two degrees and a D65 light source. Thus, the tristimulus values X, Y, and Z were calculated, and Y was used as the parallel transmittance (Tp). Tc was obtained as follows. The spectral transmittance in a crossed Nicols state was measured in the wavelength range of 380 to 780 nm using a UV-visible spectrophotometer (product name: V7100, available from by JASCO Corporation), followed by relative spectral responsivity correction assuming the field of view of two degrees and a D65 light source. Thus, the tristimulus values X, Y, and Z were calculated, and Y was used as the crossed transmittance (Tc). When Ts is nearly equal to 40%, CR≥40 was rated Good; 40>CR≥10 was rated Fair; and 10>CR was rated Poor. Table 1 shows the results.

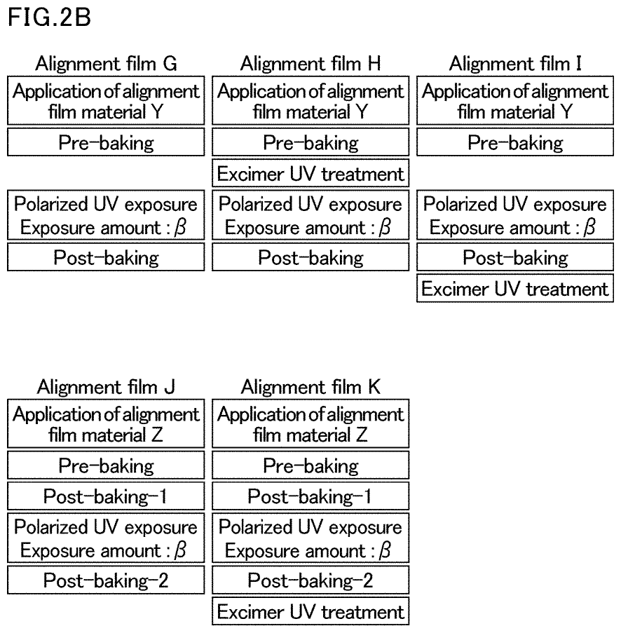

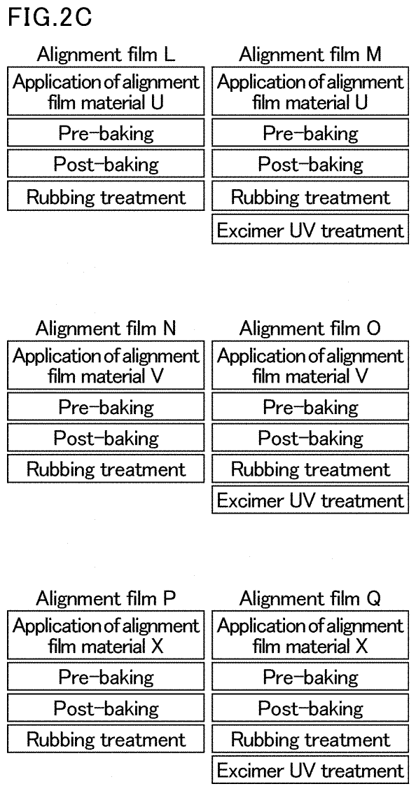

FIG. 3 is a schematic view illustrating an alignment direction a. FIG. 4 is a schematic view illustrating an alignment direction b. For each of the polarizing plates of Examples 1 to 3 and Comparative Examples 1 to 14, the slow axis of the alignment film was measured using a dual-rotating retarder polarimeter (trade name: Axo-scan, available from Axometrics Inc.) at a wavelength of 550 nm. As shown in FIG. 3, the alignment direction in a case where the transmission axis 10B of the polarizing plate was parallel to the slow axis 100SA of the alignment film was defined as a. As shown in FIG. 4, the alignment direction in a case where the absorption axis 10A of the polarizing plate was parallel to the slow axis 100S of the alignment film was defined as b. Table 1 shows the results. The absorption axis 10A of the polarizing plate was parallel to the major axis of the lyotropic liquid crystal compound (molecular axis 200MA). The transmission axis 10B of the polarizing plate was parallel to the column axis 200CA of the columnar structure (laminate 200S) composed of the lyotropic liquid crystal compound 200M.

### (Evaluation (Large Size Test) of Examples 1 to 3 and Comparative Examples 1 to 3, 9, and 10)

A large polarizing plate in a size of 400 mm×500 mm was produced for each of the following polarizing plates which were evaluated good in a small size of 5 cm×5 cm: the polarizing plate of Comparative Example 1 including the alignment film A; the polarizing plate of Comparative Example 2 including the alignment film B; the polarizing plate of Example 1 including the alignment film C; the polarizing plate of Comparative Example 3 including the alignment film D; the polarizing plate of Example 2 including the alignment film F; the polarizing plate of Example 3 including the alignment film I; the polarizing plate of Comparative Example 9 including the alignment film L; and the polarizing plate of Comparative Example 10 including the alignment film M. The produced polarizing plates were each subjected to a large size test.

In the large size test, the large polarizing plates of Examples 1 to 3 and Comparative Examples 1 to 3, 9, and 10 were each placed on a backlight in combination with a PVA polarizing plate for inspection of the same size. The alignment direction and the uniformity of alignment across the entire substrate were visually checked. Table 1 shows the results.

TABLE 1

| | | | | | | Alignment | Standard | Contact | | Small size test | | Large size test | |
|---|---|---|---|---|---|---|---|---|---|---|---|---|---|
| | | | | | | direction | condition | angle | | | Alignment | | Alignment |
| | | Alignment | | | Excimer | of nematic | for liquid | with | | | direction of | Observation of | direction of |
| | Alignment | film | | Alignment | UV | liquid | crystal | water | Retardation | Polarization | polarizing | appearance of test | polarizing |
| | film | material | Characteristics | treatment | irradiation | crystals | displays | [°] | [nm] | properties | plate | substrate | ink |
| Comparative | A | Alignment | Azo polyimide | Photoalignment | Absent | a | Applicable | 65 | 2.7 | Good | a | Poor: Misalignment at | a/b |
| Example 1 | | film | isomerization type | | | (orthogonal | | | | | | periphery of substrate | |
| Comparative | B | material X | photoalignment film | | Before | to | — | 63 | 1.1 | Good | a | Poor: Misalignment at | a/b |
| Example 2 | | | | | exposure to | polarization | | | | | | periphery of substrate | |
| | | | | | polarized light | exposure | | | | | | | |
| Example 1 | C | | | | After post- | transmission | — | 45 | 2.1 | Good | b | Good | b |
| | | | | | baking | axis) | | | | | | | |
| Comparative | D | | Azo polyimide | Photoalignment | Absent | | — | 62 | 0.84 | Good | b | Poor: Misalignment at | b/a |
| Example 3 | | | isomerization type | | | | | | | | | periphery of substrate | |
| | | | photoalignment film | | | | | | | | | | |
| Comparative | E | | (irradiation amount: | | Before | | — | 60 | 0.17 | Good | a | — | — |
| Example 4 | | | 1/20 of normal condition) | | exposure to | | | | | | | | |
| | | | | | polarized light | | | | | | | | |
| Example 2 | F | | | | After post- | | — | 41 | 0.65 | Good | b | Good | b |
| | | | | | baking | | | | | | | | |
| Comparative | G | Alignment | Dimerization and | Photoalignment | Absent | | Applicable | 61 | 6.22 | Fair to Poor | b | — | — |
| Example 5 | | film | isomerization type | | | | | | | | | | |
| Comparative | H | material Y | photoalignment film | | Before | | — | 60 | 0.19 | Poor | — | — | — |
| Example 6 | | | containing aromatic | | exposure to | | | | | | | | |
| | | | group | | polarized light | | | | | | | | |
| Example 3 | I | | | | After post- | | — | 50 | 3.9 | Good | b | Good | b |
| | | | | | baking | | | | | | | | |
| Comparative | J | Alignment | Degradation type | Photoalignment | Absent | | Applicable | 60 | — | Poor | — | — | — |
| Example 7 | | film | alignment film containing | | | | | | | | | | |
| Comparative | K | material Z | no aromatic group | | After post- | | — | 47 | — | Poor | — | — | — |
| Example 8 | | | | | baking | | | | | | | | |
| Comparative | L | Alignment | Rubbed alignment film | Rubbing | Absent | a | Applicable | 65 | — | Poor | — | Good: Note that | a |
| Example 9 | | film | containing aliphatic | | | (rubbing | | | | | | uneven drying is likely | |
| | | material U | group | | | direction) | | | | | | to occur as substrate | |
| | | | | | | | | | | | | is water-repellent | |
| Comparative | M | | | | After post- | | — | 29 | — | Poor | — | Fair to Good: | a |
| Example 10 | | | | | baking | | | | | | | Occurrence of area of | |
| | | | | | | | | | | | | sligt misalignment | |
| Comparative | N | Alignment | Rubbed alignment film | Rubbing | Absent | | Applicable | 60 | — | Poor | | | |
| Example 11 | | film | containing aromatic | | | | | | | | | | |
| Comparative | O | material V | group | | After post- | | — | 22 | — | Fair to Good | a | — | — |
| Example 12 | | | | | baking | | | | | | | | |
| Comparative | P | Alignment | Azo polyimide | Rubbing | Absent | | — | — | — | Good | a | — | — |
| Example 13 | | film | isomerization type | | | | | | | | | | |
| Comparative | Q | material X | photoalignment film | | After post- | | — | — | — | Good | a | — | — |
| Example 14 | | | | | baking | | | | | | | | |

The evaluation results indicate that a lyotropic liquid crystal compound may not be aligned even with alignment films used for liquid crystal displays, as shown in the results of the alignment film J (decomposition-type photoalignment film) and the alignment film L (rubbed alignment film). The results suggest that alignment films containing no aromatic group are less likely to align a lyotropic liquid crystal compound whether the alignment films have been subjected to rubbing or photoalignment treatment.

The evaluation revealed that when a photoalignment film satisfies the conditions of the alignment direction a in which the slow axis of the alignment film is parallel to the column axis, defects such as rotation or disorder of the alignment direction at the periphery of the substrate occur, resulting in unstable alignment in a large polarizing plate. In contrast, when the alignment film satisfies the conditions of the alignment direction b in which the slow axis of the alignment film is parallel to the molecular axis of the lyotropic liquid crystal compound (the absorption axis of the polarizing plate is parallel to the slow axis of the alignment film) and the static contact angle with water thereof is 60° or less, stable alignment equivalent to that of a small polarizing plate can be achieved across the entire substrate in a large polarizing plate.

The following is a hypothesis about the alignment direction. Normal nematic liquid crystals for liquid crystal displays are generally aligned along the slow axis of the alignment film. Therefore, the alignment film polymer and the column axes usually interact with each other to align the columns. This is the alignment direction a. In contrast, when the alignment film is hydrophilized, the interaction between the alignment film and the individual molecules (lyotropic liquid crystal compound) is enhanced due to COOH, OH, and SO₃H groups, for example. As a result, presumably, the force to align the individual molecules of the lyotropic liquid crystal compound is stronger than the force to align the columns. This is the alignment direction b.

According to the result of the alignment film A, the column axis was aligned along the sufficiently imidized alignment film polymer due to the interaction thereof with the alignment film polymer. However, presumably, a large interaction is required to align the axis of the column, which is a stack, and the interaction may become inadequate when the alignment film used is large, possibly causing a disorder in the alignment direction.

According to the result of the alignment film D, packing of PAA (polyamic acid) did not proceed well, resulting in a low degree of imidization. Accordingly, the alignment film contained many COOH residues to be more hydrophilic, which caused the alignment in the alignment direction b. However, presumably, the alignment film was partly imidized and was unstable, and such an alignment film when in a large size had an area of misalignment.

In contrast, the alignment films C, F, and I, which underwent hydrophilization at the final stage of alignment film deposition, contained OH groups/COOH groups formed by the hydrophilization, resulting in the alignment in the alignment direction b. In addition, hydrophilization such as excimer UV irradiation also partly broke the molecular structure of polyimide, which possibly reduced the inhibitory factors that inhibit the stabilization of the alignment of the lyotropic liquid crystal compound, stabilizing the alignment properties.

The reason why the alignment direction of the rubbed alignment film does not change with or without hydrophilization is unknown. Still, the column axis presumably tends to follow the rubbing direction due to the alignment order of the rubbed alignment film.

### REFERENCE SIGNS LIST

1: Display device
10: Polarizing plate
10A: Absorption axis
10B: Transmission axis
20: Display panel
100: Alignment film
100F: Direction in which alignment regulating force is
applied (alignment regulating force direction)
100SA: Slow axis
200: Polarizing layer
200CA, 201 CA: Column axis
200M: Lyotropic liquid crystal compound
200MA, 201M A: Molecular axis
200S, 201S: Laminate
201M: Dichroic dye molecule (lyotropic liquid crystal compound)

What is claimed is:

1. A polarizing plate comprising:
an alignment film; and
a polarizing layer on the alignment film,
the alignment film containing an alignment film polymer, having a static contact angle with water of 60° or smaller, and having a slow axis,
the polarizing layer containing a lyotropic liquid crystal compound and having an absorption axis parallel to the slow axis.

2. The polarizing plate according to claim 1,
wherein the lyotropic liquid crystal compound is dichroic.

3. The polarizing plate according to claim 1,
wherein the lyotropic liquid crystal compound has a columnar structure.

4. The polarizing plate according to claim 1,
wherein the alignment film polymer contains an aromatic group.

5. The polarizing plate according to claim 1,
wherein the alignment film polymer contains at least one of a carboxy group or a hydroxy group.

6. The polarizing plate according to claim 1,
wherein the alignment film contains, as the alignment film polymer, a photoalignment film polymer containing a photofunctional group.

7. The polarizing plate according to claim 6,
wherein the photoalignment film polymer has a structure represented by the following formula (P-1): 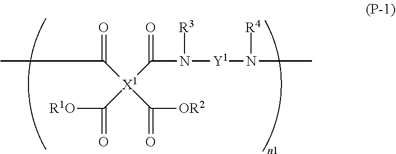
wherein X¹ represents a tetravalent organic group, Y¹ represents a divalent organic group, and at least one of X¹ or Y¹ contains at least one photofunctional group selected from the group consisting of groups obtained by removing at least one hydrogen atom from the structures represented by the following formulas (A-1) to (A-8); R¹, R², R³, and R⁴ each independently represent a hydrogen atom or a monovalent hydrocarbon group; and n1 represents an integer of 1 or larger:

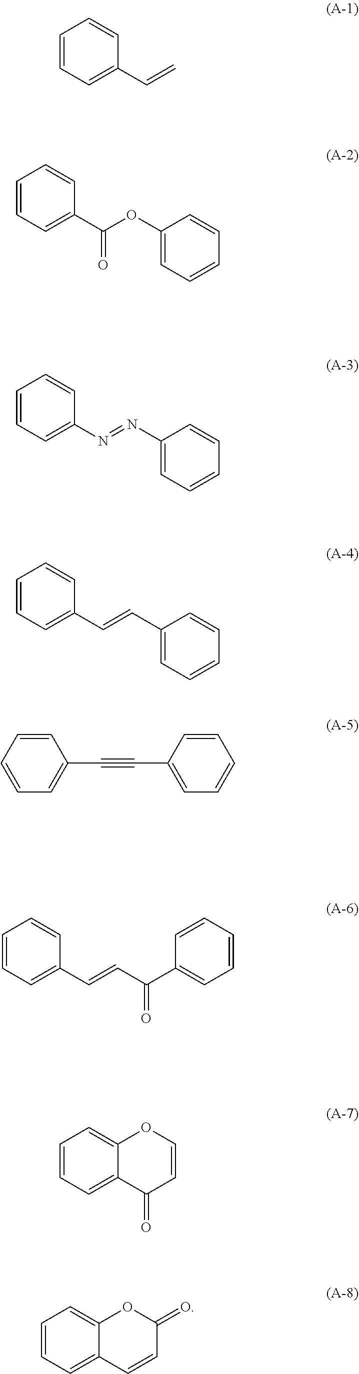

8. The polarizing plate according to claim 6,
wherein the photoalignment film polymer has a structure represented by the following formula (P-2): 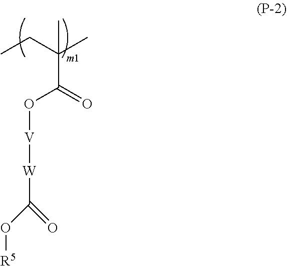
wherein V represents a divalent organic group; W contains at least one photofunctional group selected from the group consisting of groups obtained by removing at least one hydrogen atom from the structures represented by the following formulas (A-1) to (A-8); R⁵ represents a monovalent group; and m1 represents an integer of 1 or larger:

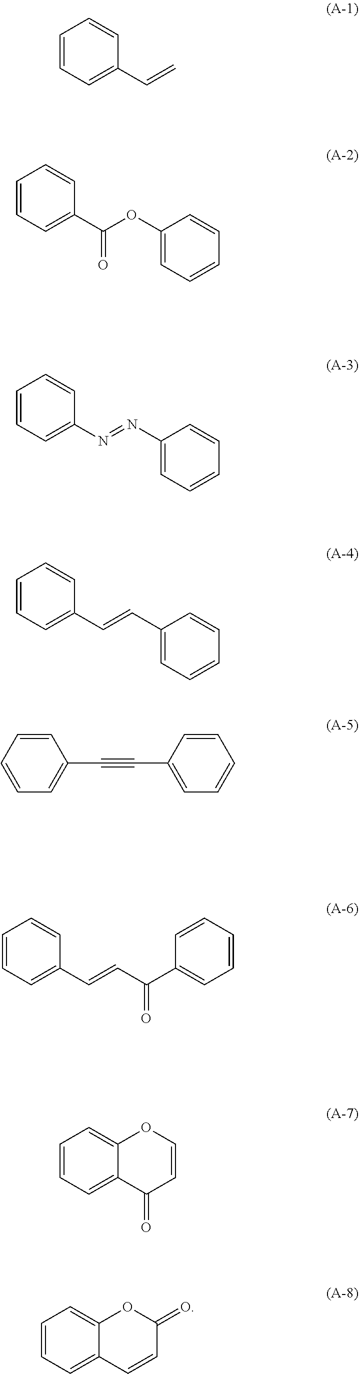

9. The polarizing plate according to claim 1,
wherein the alignment film contains, as the alignment film polymer, at least one photoalignment film polymer selected from the group consisting of a photoisomerization type polymer containing a photofunctional group that isomerizes upon irradiation with light, and a photodimerization type polymer containing a photofunctional group that dimerizes upon irradiation with light.

10. A display device comprising the polarizing plate according to claim 1.
